(19) United States
(12) Patent Application Publication
(10) Pub. No.: US 2022/0118295 A1
(43) Pub. Date: Apr. 21, 2022

(54) BIODEGRADABLE FILTER STRUCTURES

(71) Applicant: ACETATE INTERNATIONAL LLC, Irving, TX (US)

(72) Inventors: Paul BUSBY, Blacksburg, VA (US); Christopher BUNDREN, Blacksburg, VA (US); Ronald HUGHES, Blacksburg, VA (US); Gary DeHART, Blacksburg, VA (US); Michael COMBS, Sandy Spring, VA (US)

(73) Assignee: ACETATE INTERNATIONAL LLC, Irving, TX (US)

(21) Appl. No.: 17/507,160

(22) Filed: Oct. 21, 2021

Related U.S. Application Data
(60) Provisional application No. 63/094,420, filed on Oct. 21, 2020.

(51) Int. Cl. A62B 23/02; B01D 39/18; A41D 13/11

(52) U.S. Cl. CPC A62B 23/025; B01D 39/18; A41D 13/1161; B01D 2239/1258; B01D 2239/10; B01D 2239/0442; B01D 2239/1291; B01D 2239/0266; B01D 2239/0618

(57) ABSTRACT

Disclosed herein is a degradable filter structures and protective coverings including degradable filter structures. The filter structures comprise cellulose acetate and optionally plasticizer. The filter structures and protective coverings described herein degrade more rapidly than other known protective coverings.

### CROSS REFERENCE TO RELATED APPLICATION

This application claims priority to provisional application No. 63/094,420, filed on Oct. 21, 2020, the entire contents and disclosures of which are incorporated by reference herein.

### FIELD OF THE INVENTION

The present invention generally relates to biodegradable filter structures and protective coverings. In particular, the present invention relates to biodegradable filter structures and protective coverings comprising cellulose acetate (e.g., cellulose acetate tow or cellulose acetate fibers) and optionally plasticizer. The filter structures and protective coverings exhibit good air permeability, bacteria filtration efficiency, particulate filtration efficiency, and resistance to penetration.

### BACKGROUND OF THE INVENTION

Airborne contaminants are present in the environment and may present health risks to humans. Contaminants include pollutants as well as a variety of airborne respiratory infectious diseases, such as tuberculosis and measles, and emerging diseases such as severe acute respiratory syndrome (SARS), H1N1 influenza, and SARS-COVID-19. In highly polluted areas, aerosol, which is suspension of solid or liquid particles in gas, becomes the major airborne contaminant.

When it comes to the harmful effects of contaminants on the human respiratory system, the size of the contaminants is important. In general, smaller particles are more likely to become airborne and more dangerous. Particles larger than 10 μm may be collected in the upper part of the respiratory system. Therefore, most of these particles cannot get into the deep part of the lungs and may not be as harmful. However, particles smaller than 10 μm are respirable, which means that they are capable of getting into the deep part of the lungs. These particles include but are not limited to bacteria, viruses, clay, silt, tobacco smoke, and metal fumes. These smaller particles appear to have the unexplained ability to rapidly penetrate cells throughout the body and impair many cellular functions, causing problems beyond the initial respiratory infection.

According to the United States Center for Disease Control and Prevention (CDC), flu viruses are spread mainly by droplets made when people with the flu cough, sneeze, or talk. These droplets can land in the mouths or noses of people who are nearby or can possibly be inhaled into the lungs. According to the CDC, a person might also get the flu by touching a surface or object that has the flu virus on it and then touching his/her own mouth or nose. With the recent SARS-COVID-19 global pandemic, although there remains much speculations regarding exactly how the virus is spread, there is a consensus that the virus is spread from person to person as well as from surfaces to a person, much like the flu. The hazard of airborne contaminants can be managed through the application of basic controls like increasing ventilation, keeping a certain amount of separation between people, using sanitizing sprays, gels, or liquids, or providing workers with protective equipment such as protective coverings (e.g., masks). Protective masks have been widely used by personnel in hospitals, researchers in laboratories, workers in construction sites, as well as the general public in highly polluted areas or during flu season. Especially in the current environment, many countries have requirements for wearing masks in certain environments. Typically, the common mask being worn is a non-medical grade fabric or single-use mask. Such masks have varying levels of protection and may not actually serve to protect the wearer from the contaminant. Comfort and fit may also be barriers to the user wearing the mask or wearing it properly.

A protective mask is typically composed of a filtering barrier, which is a critical component that determines the protection level of the mask. Most filtering barriers of the conventional protective masks are made of polymers such as polypropylene. Polypropylene (PP) has been widely used industrially in producing protective masks due to its low cost, chemical resistance, effective water and gas barrier properties. On the other hand, PP is a petroleum-derived product, highly stable, and takes long time for degradation (e.g., at least 20 years). Consequently, conventional protective masks have very low degradability and accumulate unwanted waste due to these polymers, while also suffering from variable effectiveness and user compliant due to discomfort.

With the increasing use of protective masks to prevent the spread of airborne diseases, such as SARS-COVID-19, there is a simultaneous increase of waste from used protective masks. Accordingly, there is a need for protective masks that are biodegradable and still maintain the minimum standards of breathability, bacteria filtration efficiency, particulate filtration efficiency, and resistance to penetration.

### SUMMARY OF THE INVENTION

In some embodiments, the present disclosure is directed to a protective covering comprising a filter structure comprising cellulose acetate and optionally plasticizer, wherein the filter structure has an average air permeability from 450 cm³/s to 95,000 cm³/s. In some aspects, the cellulose acetate comprises cellulose acetate tow, cellulose acetate fibers, cellulose acetate staple fibers, melt-spun cellulose acetate fibers, electro-spun cellulose acetate fibers, or combinations thereof. In some aspects, the cellulose acetate is non-woven. In some aspects, the cellulose acetate comprises from 1 denier per filament to 4 denier per filament. In some aspects, the cellulose acetate comprises from 15,000 total denier to 45,000 total denier. In some aspects, the cellulose acetate has a filament count from 10,000 filaments to 25,000 filaments. In some aspects, the filter structure comprises an antimicrobial on a front side or a back side of the filter structure. In some aspects, the filter structure has a bacteria filtration efficiency of at least 50% as measured by ASTM F2101 (2020). In some aspects, the filter structure has a particle filtration efficiency of at least 50% as measured by ASTM F2100 (2020). In some aspects, the filter structure comprises cellulose acetate tow and plasticizer, wherein an amount of plasticizer ranges from 0.1 wt. % to 25 wt. %, based on the total weight of cellulose acetate tow. In some aspects, the plasticizer comprises triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, carbowax, glycerin, and combinations thereof. In some aspects, the plasticizer comprises triacetin. In some aspects, the filter structure comprises cellulose acetate tow and plasticizer in a ratio from 100:1 to 3:1.

In some embodiments, the present disclosure is directed to a protective covering comprising a protective covering comprising: an outer layer; an inner layer opposite the outer layer, the outer layer and the inner layer being connected; and a middle layer disposed between the outer layer and the inner layer, wherein at least one of the outer layer, inner layer, or middle layer comprises cellulose acetate and optionally plasticizer, wherein the cellulose acetate comprises cellulose acetate tow, cellulose acetate fibers, cellulose acetate staple fibers, melt-spun cellulose acetate fibers, electro-spun cellulose acetate fibers, or combinations thereof. In some aspects, the cellulose acetate is non-woven. In some aspects, the cellulose acetate comprises from 1 denier per filament to 4 denier per filament. In some aspects, the cellulose acetate comprises from 28,000 total denier to 45,000 total denier. In some aspects, the cellulose acetate has a filament count from 10,000 filaments to 25,000 filaments. In some aspects, the at least one of the outer layer, inner layer, or middle layer comprises an antimicrobial. In some aspects, the at least one layer has a bacteria filtration efficiency of at least 50% as measured by ASTM F2101 (2020). In some aspects, the at least one layer has a particle filtration efficiency of at least 50% as measured by ASTM F2100 (2020). In some aspects, the at least one layer comprises cellulose acetate tow and plasticizer, wherein an amount of plasticizer ranges from 0.1 wt. % to 25 wt. %, based on the total weight of cellulose acetate tow. In some aspects, the plasticizer comprises triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, carbowax, glycerin, and combinations thereof. In some aspects, the plasticizer comprises triacetin. In some aspects, the at least one layer comprises cellulose acetate tow and plasticizer in a ratio from 100:1 to 3:1.

In some embodiments, the present disclosure is directed to a protective covering comprising: an outer layer; an inner layer attached to the outer layer to form a pocket; and a filter structure disposed in the pocket, the filter structure comprising cellulose acetate and optionally plasticizer and having an average air permeability from 450 cm³/s to 95,000 cm³/s, wherein the cellulose acetate comprises cellulose acetate tow, cellulose acetate fibers, cellulose acetate staple fibers, melt-spun cellulose acetate fibers, electro-spun cellulose acetate fibers, or combinations thereof. In some aspects, the outer layer and inner layer are a single layer. In some aspects, the outer layer and inner comprises cellulose acetate tow, cellulose acetate fibers, cellulose acetate staple fibers, melt-spun cellulose acetate fibers, electro-spun cellulose acetate fibers, or combinations thereof. In some aspects, the filter structure has a bacteria filtration efficiency of at least 50% as measured by ASTM F2101 (2020). In some aspects, the filter structure has a particle filtration efficiency of at least 50% as measured by ASTM F2100 (2020). In some aspects, the protective covering further comprises an attachment strap comprising a biodegradable material. In some aspects, the outer layer and the inner layer comprise a bio-based material. In some aspects, the bio-based material comprises one or more of cellulose acetate, viscose, rayon, cotton, wool, bamboo, tencel, linen, or hemp. In some aspects, the filter structure comprises cellulose acetate tow and plasticizer, wherein an amount of plasticizer ranges from 0.1 wt. % to 25 wt. %, based on the total weight of cellulose acetate tow. In some aspects, an amount of plasticizer ranges from 0.1 wt. % to 25 wt. %, based on the total weight of cellulose acetate tow. In some aspects, the plasticizer comprises triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, carbowax, glycerin, and combinations thereof. In some aspects, the plasticizer comprises triacetin. In some aspects, the filter structure comprises cellulose acetate tow and plasticizer in a ratio from 100:1 to 3:1.

In some embodiments, the present disclosure is directed to a filter structure comprising: cellulose acetate tow; and a plasticizer, wherein the filter structure has a bacteria filter efficiency of at least 50% as measured by ASTM F2101 (2020), wherein the filter structure has a particle filter efficiency of at least 50% as measured by ASTM F2100 (2020), and wherein the filter structure has an average air permeability from 450 cm³/s to 95,000 cm³/s. In some aspects, the filter structure has a bacteria filter efficiency of at least 70% as measured by ASTM F2101 (2020), wherein the filter structure has a particle filter efficiency of at least 80% as measured by ASTM F2100 (2020), and wherein the filter structure has an average air permeability from 28,000 cm³/s to 48,000 cm³/s. In some aspects, filaments of the cellulose acetate tow have a cross-sectional shape selected from the group comprising circular, substantially circular, crenulated, ovular, substantially ovular, polygonal, substantially polygonal, dog-bone, “Y,” “X,” “K,” “C,” multi-lobe, and any combination thereof. In some aspects, the plasticizer is provided in an amount from 0.1 wt. % to 25 wt. %, based on the total weight of cellulose acetate tow. In some aspects, the plasticizer comprises one or more of triacetin, carbowax, polyethylene glycol, and glycerin. In some aspects, the filter structure comprises cellulose acetate tow and plasticizer in a ratio from 100:1 to 3:1. In some aspects, the filter structure weighs from 50 gsm to 200 gsm and has a thickness less than 2 mm. In some aspects, the cellulose acetate tow comprises from 1 denier per filament to 4 denier per filament, wherein the cellulose acetate tow comprises from 28,000 total denier to 45,000 total denier, wherein the cellulose acetate tow has a filament count from 10,000 filaments to 25,000 filaments.

In some embodiments, the present disclosure is directed to a method of producing a filter structure, the method comprising: providing a cellulose acetate tow; spreading the cellulose acetate tow through an air banding jet to open the cellulose acetate tow; optionally deregistering the cellulose acetate tow to spread fibers of the cellulose acetate tow; bulking the cellulose acetate tow using an air jet; applying plasticizer to the bulked cellulose acetate tow; calendaring the bulked tow between heated rollers operating in a temperature range from 65° C. and 125° C.; and cutting the bulked tow to form a filter structure. In some aspects, an amount of plasticizer added to the cellulose acetate tow ranges from 0.1 wt. % to 25 wt. %, based on the total weight of the cellulose acetate tow. In some aspects, an amount of plasticizer added to the cellulose acetate tow is from 0.5 wt. % to 20 wt. % based on the total cellulose acetate tow, the calendaring temperature is from 65° C. and 125° C., wherein a bacteria filter efficiency of the filter structure is at least 50% as measured by ASTM F2101 (2020), wherein a particle filter efficiency of the filter structure is at least 50% as measured by ASTM F2100 (2020), and wherein an average air permeability of the filter structure is from 450 cm³/s to 95,000 cm³/s.

### DESCRIPTION OF THE DRAWINGS

The present invention will be better understood in view of the appended, non-limiting figures, wherein:

FIG. 1 shows a degradable protective covering in accordance with embodiments of the present disclosure.

FIGS. 2A and 2B show a degradable filter structure for use as an insert in a protective covering in accordance with embodiments of the present disclosure.

FIGS. 3A-3D show a degradable protective covering including a film layer in accordance with embodiments of the present disclosure.

### DETAILED DESCRIPTION OF THE INVENTION

For the purposes of this specification and appended claims, unless otherwise indicated, all numbers expressing quantities of ingredients, percentages or proportions of materials, reaction conditions, and other numerical values used in the specification and claims, are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein. For example, a range of “1 to 10” includes any and all subranges between (and including) the minimum value of 1 and the maximum value of 10, that is, any and all subranges having a minimum value of equal to or greater than 1 and a maximum value of equal to or less than 10, e.g., 5.5 to 10.

It is noted that, as used in this specification and the appended claims, the singular forms “a,” “an,” and “the,” include plural referents unless expressly and unequivocally limited to one referent. Thus, for example, reference to “a layer” includes one, two or more layer(s).

Reference will now be made in detail to certain embodiments of the present disclosure, examples of which are illustrated in the accompanying drawings. While the invention will be described in conjunction with the illustrated embodiments, it will be understood that they are not intended to limit the invention to those embodiments. On the contrary, the present disclosure is intended to cover all alternatives, modifications, and equivalents, which may be included within the invention as defined by the appended claims.

The headings below are not meant to limit the disclosure in any way; embodiments under any one heading may be used in conjunction with embodiments under any other heading.

### I. INTRODUCTION

A filter structure in a protective covering is designed to protect the wearer from particulate matter and airborne pathogens (e.g., bacteria and/or viruses). In some cases, protective coverings include one or more filter structures to purify or prevent inhalation of particulates or airborne pathogens. Protective coverings are widely used by workers in a variety of industries, including healthcare, pharmaceuticals, construction, defense, public safety, industrial manufacture, agriculture, and textiles. In some cases, the United States Center for Disease Control has even called on all citizens to wear a protective coverings in public settings to reduce the spread of infectious diseases.

In the United States, the National Institute for Occupational Safety and Health (NIOSH) defines air filtration ratings to classify the effectiveness of the filter structures used in protective coverings. In particular, NIOSH classifies filter structures on the basis of a variety of performance characteristics. The N95 standard for filter structures and protective covering is an exemplary NIOSH air filtration rating. Because N95-approved filter structures and protective coverings demonstrate excellent properties (e.g., high fluid resistance, high filtration efficiency), N95 protective coverings are particularly useful in medical environments to prevent the transmission of airborne diseases, such as influenza and SARS-COVID-19.

Conventional protective coverings and filter structures, however, are not biodegradable and do not effectively filter bacteria or particulates while maintaining good breathability characteristics. The present disclosure is directed to filter structures and degradable protective coverings incorporating one or more filter structures comprising cellulose acetate (e.g., cellulose acetate tow or cellulose acetate fibers) and optionally plasticizer. By including one or more filter structures in lieu of the standard filter (e.g., polypropylene filters) used in conventional masks, the protective coverings described herein improve biodegradability while maintaining good breathability and filtration efficiency of particulate matter and airborne pathogens.

In some embodiments, the protective covering comprises a filter structure comprising cellulose acetate and optionally plasticizer. The cellulose acetate may comprise cellulose acetate tow, cellulose acetate fibers, cellulose acetate staple fibers, melt-spun cellulose acetate fibers, electro-spun cellulose acetate fibers, or combinations thereof. In some embodiments, the protective covering comprises an outer layer, an inner layer opposite the outer layer, and a middle layer disposed between the outer layer and the inner layer. At least one of the outer layer, middle layer, or inner layer comprises cellulose acetate (e.g., cellulose acetate tow or cellulose acetate fibers) and optionally plasticizer. For example, at least one of the outer layer, middle layer, or inner layer comprises cellulose acetate tow and a plasticizer. The plasticizer can be added to the cellulose acetate tow from 0.1 wt. % to 25 wt. %, based on the total weight of the cellulose acetate tow. The ratio of cellulose acetate tow and plasticizer can be from 100:1 to 3:1. The one or more layers comprising the cellulose acetate tow and plasticizer exhibits good breathability, bacteria filtration efficiency, particulate filtration efficiency, and resistance to penetration. In some aspects, the filter structure is not a single thin-film layer.

In some embodiments, the protective covering comprises a layer (e.g., a single layer) comprising an opening for receiving an insert comprising a filter structure. In some aspects, the layer of the protective covering may comprise an outer layer attached along the perimeter to an inner layer to form seam to form a pocket for an insert comprising a filter structure. The filter structure may comprise cellulose acetate (e.g., cellulose acetate tow or cellulose acetate fibers) and optionally plasticizer. The insert can be provided in the pocket to aid in filtering particulates and airborne pathogens. The insert can be removed from the protective covering and disposed or can be washed and re-used.

In some embodiments, the protective covering includes one or more film layer(s) and a filter structure. The filter structure may comprise cellulose acetate (e.g., cellulose acetate tow or cellulose acetate fibers) and optionally plasticizer. The film may comprise cellulose diacetate (e.g., CLARIFOIL®). The film may be transparent. In some aspects, the film may divert airflow towards the filter structure. In this configuration, the film layer may reduce unwanted particulates and bacteria to specific regions of a user (e.g., eyes) and redirect airflow to the filter structure to effectively filter particulates and airborne pathogens.

The filter structures comprising cellulose acetate filtration media enables high filtration efficiency and limits differential pressure within the mask allowing for greater comfort and perceived breathability. The filter structures described herein reduce pressure drop and enhance filtration of airborne particles. An advantage of the cellulose acetate arrangements described herein is that such arrangements allow for good breathability, bacteria filtration efficiency, particulate filtration efficiency, and resistance to penetration. Further, the filter structures described herein have a total degradation value of over 80%, e.g., over 85%, over 90%, or even over 95%. Total degradation may be measured by measuring mg CO₂ production according to ISO 19679 (2020). Such a total degradation allows the cellulose acetate to degrade like cellulose, opening up possibilities for recycling the filter structures once they have been degraded to cellulose. The filter structures described herein therefore degrade more rapidly than other known protective coverings.

Additionally, the degradable filter structures allows for reduced pressure differential (internal to ambient air) and enhanced filtration of bacteria and airborne particles. The degradable protective covering improves filtration and/or reduces breathing resistance (e.g., provides wearer comfort) while protecting the wearer from airborne particles less than 10 microns (e.g., including viruses, bacteria, spores, mold, dust and diffuse airborne chemical pollutants, etc.). In some embodiments, the filter structures allows consistent pressure, comfort, and consistent temperatures within the protective covering for the user when the protective covering is worn.

### II. FILTER STRUCTURES/PROTECTIVE COVERINGS

As described herein, the present disclosure relates to filter structures and protective coverings including one or more filter structures comprising cellulose acetate (e.g., cellulose acetate tow or cellulose acetate fibers) and optionally plasticizer. In some embodiments, the filter structure may comprise non-woven cellulose acetate tow with or without plasticizer.

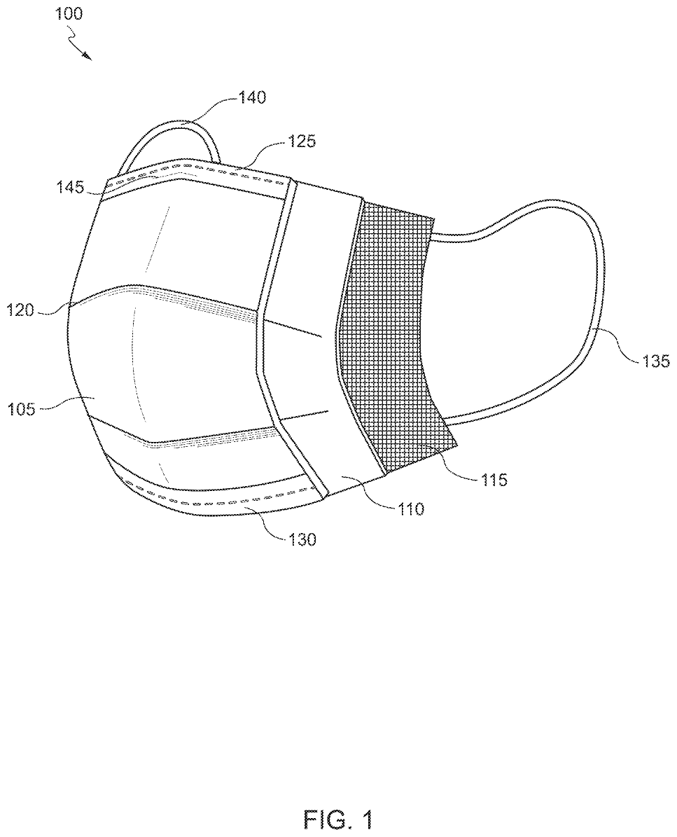

FIG. 1 illustrates a protective covering 100 according to various embodiments of the present disclosure. The protective covering 100 comprises an outer layer 105, an inner layer 110, and a middle layer 115. As used herein, the inner layer 110 refers to a layer (or layers) that is closest to the user's face and the outer layer 105 refers to a layer (or layers) that is furthest further from the user's face. The outer layer 105 is configured to contact the external environment. The middle layer 115 (or layers) is disposed between the outer layer 105 and the inner layer 110. In some embodiments, the protective covering 100 may comprise one or more additional layers between the outer layer 105 and the inner layer 110 for improved filtration. In some embodiments, the protective covering 100 may only comprise an outer layer 105 and a middle layer 115. In some embodiments, the protective covering 100 may only comprise an inner layer 110 and a middle layer 115. In some embodiments, the protective covering may comprise a single layer.

The protective covering 100 is generally configured to provide a secure fit which reduces or prevents gaps and passage of material between the nostrils and mouth and the surrounding environment except through the outer layer 105. In some embodiments, the protective covering 100 has pleating 120. The pleats 120 are disposed between the upper edge 125 and lower edge 130 and may be incorporated in the body of the filter material to hold the protective covering 100 in a cup-like shape when installed. In some embodiments, the protective covering 100 comprises two ear loops 135 and 140 to maintain a secure fit upon installation of the protective covering 100 on the face.

In the embodiment shown in FIG. 1, at least one of the outer layer 105, the inner layer 110, or the middle layer 115 may serve as the filter structure. The filter structure may comprise cellulose acetate (e.g., cellulose acetate tow or cellulose acetate fibers) and optionally plasticizer. In some embodiments, the outer layer 105 and the inner layer 110 may comprise a wide variety of materials and is preferably disposable. The outer layer 105, the inner layer 110, or the middle layer 115 used to fabricate the protective covering 100 may vary according to the particular application of the protective covering 100. For example, when the protective covering 100 is to be used in a medical application, such as on members of a surgical team, it is common to use a three layer filter material that will provide blood (or other) fluid resistance to prevent penetration of fluids to the inner lining of the mask. However, appropriate inner, outer, and filtration materials may be of a single or multiple layer design. Multi-layer material may be readily purchased in a precollated form, that is with the three layers already arranged, or the materials may be obtained separately and the filter material formed in part of the process for forming the protective covering 100.

In some embodiments, the protective covering 100 includes outer layer(s) 105 comprising a material which provides durability and resistance against abrasion and/or fluid penetration. The outer layer(s) 105 may also be generally stiffer than the other layers. By using a stiffer outer layer, the effectiveness of the various pleating arrangements is increased. The pleats 120 are disposed between the upper edge 125 and lower edge 130 and may be incorporated in the body of the middle layer 115 to hold the protective covering 100 in a cup-like shape. The inner layer 110 or layers of the protective covering 100 may generally comprise the same material as the outer layer 105. The inner layer 110 or of the protective covering 100 is to be worn next to or against the face and generally comprises a soft material for providing a soft, non-irritating surface against which the facial skin will make contact. In some embodiments, the outer layer 105 and inner layer 110 may comprise a bio-based material. In some embodiments, the bio-based material may be one or more of cellulose acetate, viscose, rayon, cotton, wool, bamboo, tencel, linen, or hemp. In some embodiments, the outer layer 105 and/or inner layer 110 may be comprise an antimicrobial (e.g., antimicrobial coating). The antimicrobial may be sprayed on or applied with spray roller brushes a front side or a back side of the outer layer and/inner layer.

In the embodiment shown in FIG. 1, the middle layer 115 of the protective covering 100 comprises the filter structure. In some aspects, the filter structure may comprise cellulose acetate (e.g., cellulose acetate tow or cellulose acetate fibers) and optionally plasticizer. In some aspects, the filter structure may comprise cellulose acetate fibers (e.g., melt-spun cellulose acetate fibers or cellulose acetate staple fibers). In some aspects, the middle layer consists essentially of cellulose acetate tow and a plasticizer (e.g., no other polymer which contributes to the filtration is present, though other components, such as pigments, may be present). In some aspects, the middle layer consists of cellulose acetate tow and plasticizer. In aspects where the middle layer contains more than one layer, at least one of the layers may consist essentially of or consist of cellulose acetate tow and the plasticizer. In some aspects, the filter structure may comprise non-woven cellulose acetate.

In some embodiments, the structure of the protective covering 100 is generally prepared as a rectangular piece of flat material. However, it will be understood by those of ordinary skill in the art that other shapes of the face mask can be made in order to cover other areas of the face. As such, the present application includes of the protective covering 100 that cover areas above and beyond simply the nose and mouth of the user. The facemask may also incorporate any combination of known of the protective covering 100 features, such as visors or shields, sealing films, beard covers, etc.

In some embodiments, the protective covering 100 comprises a ductile part 145 attached to or imbedded in the protective covering 100 at the upper edge 125. The ductile part 145 is configured to conform the outer layer 105, the inner layer, 110, and the middle layer 115 to at least a nose portion and a cheek portion of the face of the wearer. It will cause a portion of the protective covering 100 to be convex and have, in some embodiments a curved projection on the outer layer to indicate the nose and cheek area. In some embodiments, the protective covering 100 may further include a second ductile part attached to or within lower edge of the protective covering 100. The second ductile part is configured to conform the mask material to at least a chin portion and a jaw portion of the face of the wearer. The ductile part may be a material that is pliant enough to be bent to a shape that conforms to the face of the wearer, and then retain that shape. The ductile parts can comprise any pliant material, such as a malleable metal or alloy, plastic, or the like. In some embodiments, the ductile parts comprise aluminum or other binding material which exhibits stiffening characteristics.

The protective covering 100 may be attached to the user by a securing means that can attach the mask to the user. For example, the securing means may be a pair of manual tie straps that are wrapped around the head of the user and are connected to one another, or the securing means may be ear loops (135 and 140 in FIG. 1), elastic bands wrapped around the head of the user, or a hook and loop type fastener arrangement (e.g. VELCRO® fasteners). In some embodiments, the protective covering 100 has ear loops 135 and 140 attached to edges of the mask at attachment points of the protective covering 100. In the embodiment shown in FIG. 1, the ear loops 135 and 140 are attached to the outside surface of the mask. However, it will be understood by those of ordinary skill in the art that the loops can be attached to the inside surface of the mask.

The loops may be formed from any suitable material, such as an elastic material (e.g. a polymer), inelastic material, a nonwoven, knit, ribbon, cloth, wire, and so forth. In some embodiments, the loops may comprise cellulose acetate. As used herein, the term “elastic” refers to the ability of a material to recover its size and shape after deformation. As used herein, the term “inelastic” refers to the inability of a material to recover its size and shape after deformation. In some embodiments, the loop is formed from the same material selected to form the outside surface of the mask. The loop may be bonded or otherwise affixed to the outside surface or inside surface of the mask. Examples of suitable techniques include adhesive bonding, thermal bonding, stitching, and so forth. As used herein, the term “adhesive” refers to the property of any material that allows the material to bond together substrates by surface attachment.

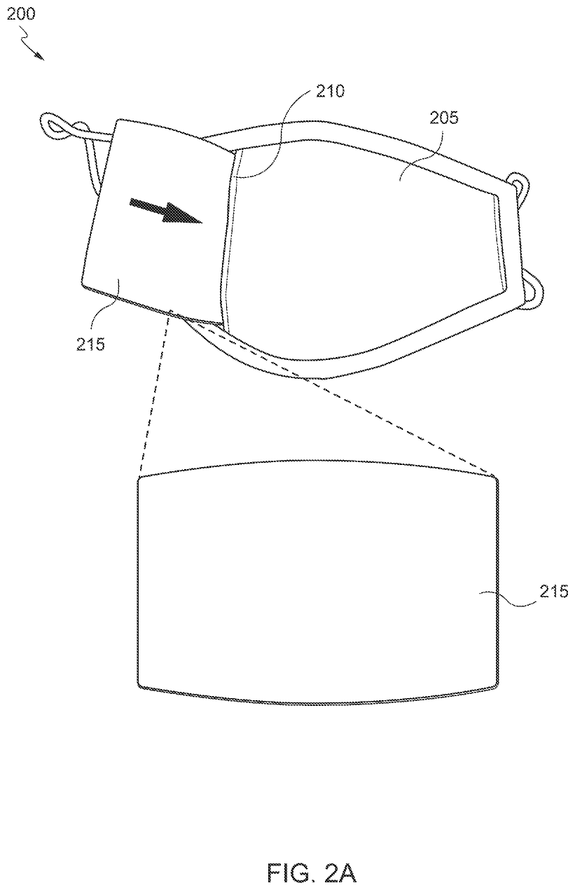

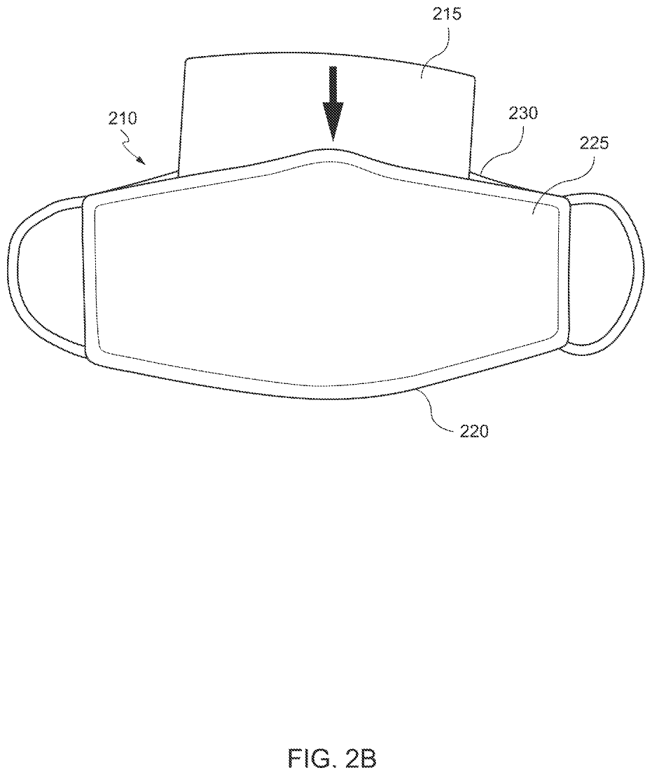

FIG. 2A shows a degradable filter structure for use as an insert in protective covering in accordance with embodiments of the present disclosure. The filter structure 215 can be used in a protective covering 200 comprising one or more layers. The protective covering 200 may comprise a single layer 205 comprising an opening 210 (e.g., pocket) for accepting an insert comprising the filter structure 215. The filter structure 215 may be inserted into the opening 210 to provide the properties discussed in Section III. For example, the filter structure 215 can be inserted in an opening 210 at the front face or rear face of the protective covering 200. The filter structure 215 may comprise cellulose acetate (e.g., cellulose acetate tow or cellulose acetate fibers) and optionally plasticizer. In some embodiments, the filter structure 215 may consist essentially of cellulose acetate tow and plasticizer or consists of cellulose acetate tow and plasticizers. The filter structure 215 can be cut to have the size and dimensions to fit within the opening 210 of the protective covering 200. In some aspects, the filter structure 215 can have a convex shape to form a cone over the mouth and nose of a user. In some embodiments, filter structure 215 is separable and/or removable from the protective covering 200. This may allow for individual components to be washed and/or replaced. In some embodiments, the filter structure 215 can be disposable such that the filter structure 215 can be replaced after a period of use.

As shown in FIG. 2B, the protective covering 200 may comprise a single layer 205 comprising an inner layer 225 and an outer layer 230. The inner layer 225 may be attached along the perimeter 220 to an outer layer 230 to form seam to form an opening 210 (e.g., pocket) for receiving the filter structure 215. The outer layer 230 may be sufficient in size to allow space for breathing, and to cover the nose/mouth region. The filter structure 215 is sized to be inserted in the opening 210 formed by inner layer 225 and outer layer 230. In some embodiments, the inner layer 225 and the outer layer 230 can be removably attached using a fastening means to selectively open and close the opening 210. For example, the inner layer 225 and the outer layer 230 may be attached using one or more of hook and loop fasteners, magnets, snaps, clasps, releasable clips, zippers, among others. The filter structure 215 is sufficient in size to allow space for breathing, and to cover the nose/mouth region.

In some embodiments, a filter support frame may be provided for the protective covering 200. The filter support frame may be inserted in the opening 210 (e.g., filter pocket) formed by inner layer 225 and the outer layer 230 and can house the filter structure 215. The filter support frame may include holes or other sufficient air passages if the size of the frame approximates the interior dimensions of the opening 210. The filter support frame is shaped to form a radius or angle opposite the nose and mouth to maintain breathing space. The filter support frame can be made of any material suitable to maintain the filter structure 215 away from the nostrils and mouth, such as plastic or polyester sheeting or film.

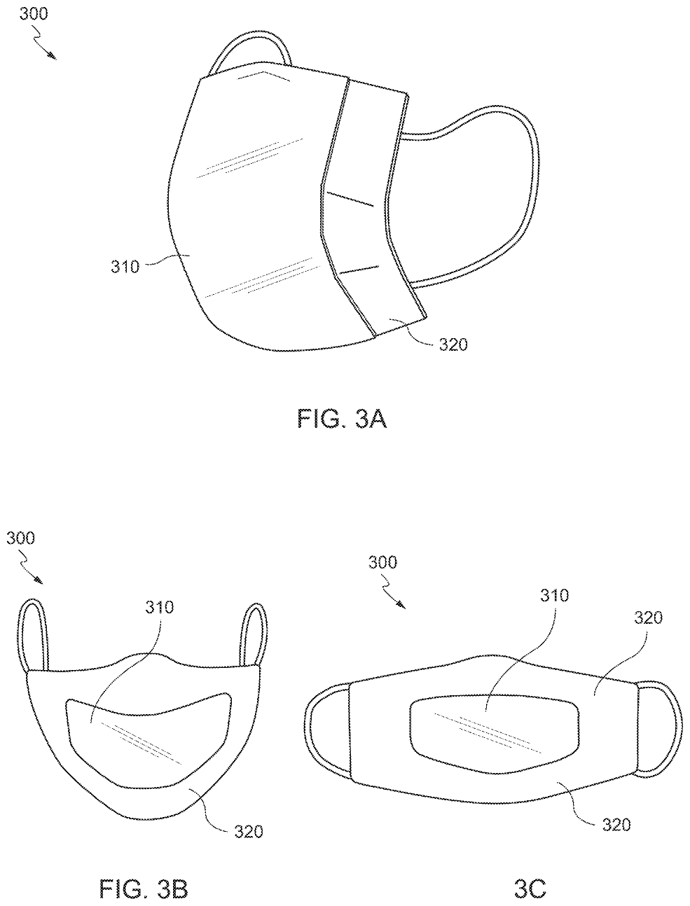

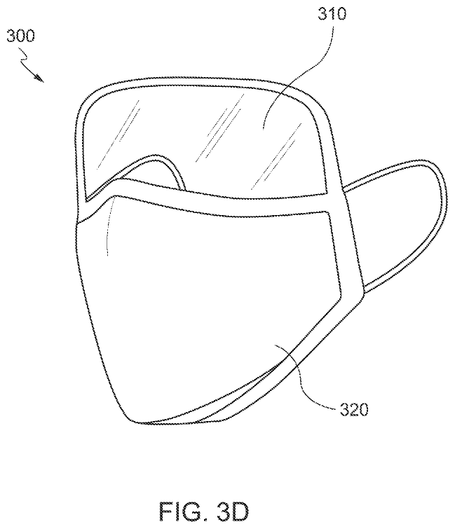

FIGS. 3A-3D show embodiments of a degradable protective covering 300 including a film or film layer in accordance with embodiments of the present disclosure. In some embodiments, the degradable protective covering may comprise one or more films and one or more filter structures. As shown in FIG. 3A, the protective covering 300 may comprise a film 310 and a filter structure 320. The filter structure 320 may comprise cellulose acetate and optionally plasticizer. In some embodiments, the film 310 may comprise one or more film layers. In some embodiments, the film 310 may be a transparent film. The film may comprise one or more of cellulose diacetate, polymers, polyethylene terephthalate, poly vinyl chloride, polypropylene, polycarbonate, polystyrene, poly(methyl methacrylate), or silicone. In some aspects, cellulose diacetate may have anti-fog properties by including anti-blocking agent. In some embodiments, the anti-blocking agent comprises an inorganic compound. For example, the anti-blocking agent may comprise oxides, carbonates, talc, clay, kaolin, silicates, and/or phosphates. In one embodiment, the anti-blocking agent may comprise titanium dioxide, aluminum oxide, zirconium oxide, silicon dioxide, calcium carbonate, calcium silicate, aluminum silicate, magnesium silicate, calcium phosphate and mixtures thereof. In one embodiment, the anti-blocking agent comprises silica.

In some aspects, the film 310 comprises cellulose diacetate. The cellulose diacetate may be CLARIFOIL®. The film 310 may divert air around the film 310 portions of the protective covering 300 towards the filter structures 320. For example, as shown in FIG. 3A, the protective covering 300 may comprise a film 310 comprising CLARIFOIL® as an outer layer and a filter structures 320 as an inner layer. In some embodiments, a portion of the protective covering 300 comprising the filter structure 320 may be exposed through the film 310. In some embodiments, the film 310 may comprise perforations for air flow directly to the filter structure 320. In other words, the film 310 may divert airflow towards regions of the protective covering 300 comprising the filter structure 320. In this way, the protective covering 300 can provide sufficient airflow through specific entry points comprising the filter structure 320 while protecting other regions from contaminants via the film 310.

As shown in FIGS. 3B and 3C, the protective covering 300 may comprise one more layers comprising a film 310 and a filter structure 320. In some embodiments, the film 310 may be a transparent film. The film 310 can be embedded in the filter structure 320 or can be removably attached to a portion of the filter structure 320. For example, the filter structure 320 can include an opening or cut-out of a desired shape. In this embodiment, the film 310 can be attached to the filter structure 320 at the region comprising the opening or cut-out. In some embodiments, the film 310 can be sandwiched between two or more layers, wherein at least one layer comprises the filter structure 320. The film 310 functions to divert airflow towards the filter structure 320. For example, the film 310 may comprise CLARIFOIL® which may divert air flow from the film 310 region to the filter structure 320. In some embodiments, the clarity of the protective covering 300 described herein may be important in some applications, e.g., high clarity (or low haze) may be necessary when the filter structure are used in conjunction with high clarity (or low haze) films (e.g., CLARIFOIL®) or high clarity laminate films (e.g., laminate or protective coatings on substrates like paper).

As shown in FIGS. 3B and 3C, the region of the protective covering 300 comprising the film 310 can comprise any suitable shape. The film 310 can be surrounded by the filter structure 320. The region comprising the film 310 can be transparent such that the mouth region of a user is visible through the film. In some embodiments, the film 310 may have any suitable shape that allows the mouth of a user to be visible. In this embodiment, the protective covering 300 may be desirable for people that have difficulty hearing and rely on lip reading or facial cues.

FIG. 3D shows an alternative embodiment of the protective covering 300 comprising a film 310. In this embodiment, the film 310 may be an upper layer and the filter structure 320 may be disposed below the film 310. In this embodiment, the film 310 of the protective covering 300 may comprise CLARIFOIL® to protect the eyes of a user from contaminants and direct airflow towards the filter structure 320. The filter structure 320 of the protective covering 300 may be disposed over the nose and mouth of a user.

### III. PROPERTIES OF FILTER STRUCTURE

In many different applications (e.g., personal, medical, dental, and surgical), it is generally important that the filter structure of the protective covering provide sufficient properties to meet the minimum standards of comfort, filtration, resistance to fluids, and flammability. For example, the bacterial filtration efficiency (BFE) of a filter structure is generally determined by the percentage of bacteria, such as Staphylococcus aureus or Bacillus stearothermophilus, that is able to migrate through the filter structure under normal conditions. The fewer bacteria which are able to pass through the protective covering, the higher the BFE.

The properties of the filter structure of protective covering described below reflect the values for a single layer of the filter structure comprising cellulose acetate (e.g., cellulose acetate tow or cellulose acetate fibers) and optionally plasticizer. ASTM International defines air filtration ratings to classify the effectiveness of the filter structures. In particular, ASTM F2100 (2020) provides classifications, performance requirements, and test methods for the filter structures used, e.g., in the construction of medical facemasks used in the healthcare industry. ASTM International classifies filter structures on the basis of performance characteristics, including fluid resistance, particulate filtration efficiency, bacterial filtration efficiency, breathability, and flammability.

In some embodiments, the filter structure of the protective covering has a BFE from 50% to 99.9% (e.g., from 60% to 99.9%, from 75% to 99.5%, from 80% to 99.5%, or from 90% to 99.9%) as measured by ASTM F2101 (2020), e.g., greater than or equal to about 50%, greater than or equal to about 60%, greater than or equal to about 65%, greater than or equal to about 70%, greater than or equal to about 75%, greater than or equal to about 78%, greater than or equal to about 80%, greater than or equal to about 82%, greater than or equal to about 84%, greater than or equal to about 85%, greater than or equal to about 86%, greater than or equal to about 88%, greater than or equal to about 90%, greater than or equal to about 92%, greater than or equal to about 94%, greater than or equal to about 95%, greater than or equal to about 96%, greater than or equal to about 98%, or greater than or equal to about 99%. In general, the considerations that provide for a high BFE are the same considerations which provide that a protective covering would be desirable in applications in industry and domestic use. For example, a filter structure which inhibits the migration of nearly all bacteria would generally also prevent inhalation of dust and dirt particles in industrial applications. Furthermore, it has generally been found that those materials providing a high BFE are often also those materials which provide the least resistance to passage of gases through the protective covering.

In some embodiments, the filter structure of the protective covering may exhibit a particle filtration efficiency (PFE) of 50% to 99.9% (e.g., from 60% to 99.9%, from 70% to 99.5%, from 80% to 99.5%, or from 90% to 99.9%) as measured by ASTM F2100 (2020), e.g., greater than or equal to about 50%, greater than or equal to about 55%, greater than or equal to about 60%, greater than or equal to about 65%, greater than or equal to about 70%, greater than or equal to about 75%, greater than or equal to about 80%, greater than or equal to about 85%, greater than or equal to about 90%, greater than or equal to about 95%, greater than or equal to about 98%, or greater than or equal to about 99%.

The filter structure may have a desired air permeability (e.g., breathability) to ensure respiratory comfort of the protective covering. The air permeability may be measured on a Frazier Precision Instrument (from Frazier Precision Instruction Company, Hagerstown, Md.). The air permeability, which expresses the permeability of a material in terms of cubic feet per minute of air through a square foot of area of a surface of the material at a pressure drop of 0.5 inch of water (or 125 Pa), can be determined utilizing a Frazier Air Permeability Tester available from the Frazier Precision Instrument Company and measured in accordance with Federal Test Method 5450, Standard No. 191A. In some embodiments, the filter structure of the protective covering may exhibit an average air permeability (e.g., breathability) from 450 standard cubic centimeters per second (cm³/s) to 100,000 cm³/s (e.g., from 2000 cm³/s to 75,000 cm³/s, 4500 cm³/s to 60,000 cm³/s, from 9000 cm³/s to 50,000 cm³/s, from 10,000 cm³/s to 45,000 cm³/s, from 14,000 cm³/s to 43,000 cm³/s, from 18,000 cm³/s to 41,000 cm³/s, from 20,000 cm³/s to 38,000 cm³/s, from 28,000 cm³/s to 45,000 cm³/s, or from 23,000 cm³/s to 43,000 cm³/s) to ensure the respiratory comfort of the protective covering. In some embodiments, the filter structure of the protective covering may exhibit an average air permeability less than 100,000 cm³/s, e.g., less than 85,000 cm³/s, less than 76,000 cm³/s, less than 71,000 cm³/s, less than 67,000 cm³/s, less than 62,000 cm³/s, less than 59,000 cm³/s, or less than 55,000 cm³/s.

In some embodiments, the filter structure may have a weight from 25 gsm to 450 gsm, e.g., from 30 gsm to 425 gsm, from 50 gsm to 400 gsm, from 75 gsm to 375 gsm, from 100 gsm to 350 gsm, from 125 gsm to 325 gsm, from 150 gsm to 300 gsm, from 100 gsm to 275 gsm, from 125 gsm to 250 gsm, or from 100 gsm to 200 gsm. In some embodiments, the weight of the filter structure ranges from 50 gsm to 150 gsm.

In some embodiments, the filter structure may have a thickness from 0.1 mm to 5 mm, e.g., from 0.15 mm to 4.5 mm, from 0.2 mm to 4 mm, from 0.3 mm to 3.5 mm, from 0.4 mm to 3 mm, from 0.5 mm to 2.5 mm, from 0.6 mm to 2 mm, from 0.7 mm to 1.5 mm, from 0.5 mm to 1.5 mm, or from 0.75 mm to 1.25 mm. In some embodiments, the thickness of the filter structure ranges from 0.7 mm to 1.1 mm.

In some embodiments, the filter structure of the protective covering may comprise a cellulose acetate having a dpf from 1.9 dpf to 3.0 dpf, a total denier from 15,000 to 45,000, plasticizer from 0.50 wt. % to 10 wt. %, and exhibits an average permeability from 2,000 cm³/s to 40,000 cm³/s, a BFE from 95% to 99.9%, and a PFE from 90% to 99.9%.

In some embodiments, the filter structure may comprise a cellulose acetate having a dpf from 2.0 dpf to 3.0 dpf, a total denier from 20,000 to 45,000, plasticizer from 0.10 wt. % to 15 wt. %, and exhibits an average permeability from 35,000 cm³/s to 60,000 cm³/s, a BFE from 70% to 80%, and a PFE from 80% to 90%.

In some embodiments, the filter structure may comprise a cellulose acetate having a dpf from 2.2 dpf to 2.8 dpf, a total denier from 28,000 to 36,000, plasticizer from 0.30 wt. % to 22 wt. %, and exhibits an average permeability from 30,000 cm³/s to 50,000 cm³/s, a BFE from 80% to 90%, and a PFE from 75% to 90%.

As appreciated by one of ordinary skill in the art, the filtration efficiency of the filter structure may increase depending on the material for other layers of the protective covering. For example, a protective covering including three layers may comprise an outer layer and inner layer each comprising a bio-based material (e.g., cellulose acetate, viscose, rayon, cotton, wool, bamboo, tencel, linen, hemp, etc.) and a middle layer comprising the filter structure. The outer and inner layer in combination with the middle layer may exhibit higher BFE, PFE, and flame resistance.

### IV. CELLULOSE ESTER

As described herein, the present disclosure relates to protective coverings comprising one or more layers including cellulose esters (e.g., a cellulose acetate tow or a layer formed from cellulose acetate tow) and optionally plasticizer. The plasticizer is included with the cellulose ester in order to aid in degradation. Cellulose acetate, as used herein, refers to cellulose diacetate, though the catalyst and methods described herein may be used for other types of cellulose esters, including cellulose triacetate, cellulose propionate, cellulose acetate-propionate, cellulose butyrate, cellulose acetate-butyrate, cellulose propionate-butyrate, cellulose nitrate, cellulose sulfate, cellulose phthalate and combinations thereof.

Cellulose esters may be prepared by known processes, including those disclosed in U.S. Pat. No. 2,740,775 and in U.S. Publication No. 2013/0096297, the entireties of which are incorporated herein by reference. Typically, acetylated cellulose is prepared by reacting cellulose with an acetylating agent in the presence of a suitable acidic catalyst and then de-esterifying.

The cellulose may be sourced from a variety of materials, including cotton linters, a softwood or from a hardwood. Softwood is a generic term typically used in reference to wood from conifers (i.e., needle-bearing trees from the order Pinales). Softwood-producing trees include pine, spruce, cedar, fir, larch, douglas-fir, hemlock, cypress, redwood and yew. Conversely, the term hardwood is typically used in reference to wood from broad-leaved or angiosperm trees. The terms “softwood” and “hardwood” do not necessarily describe the actual hardness of the wood. While, on average, hardwood is of higher density and hardness than softwood, there is considerable variation in actual wood hardness in both groups, and some softwood trees can actually produce wood that is harder than wood from hardwood trees. One feature separating hardwoods from softwoods is the presence of pores, or vessels, in hardwood trees, which are absent in softwood trees. On a microscopic level, softwood contains two types of cells, longitudinal wood fibers (or tracheids) and transverse ray cells. In softwood, water transport within the tree is via the tracheids rather than the pores of hardwoods. In some aspects, a hardwood cellulose is preferred for acetylating.

Acetylating agents can include both carboxylic acid anhydrides (or simply anhydrides) and carboxylic acid halides, particularly carboxylic acid chlorides (or simply acid chlorides). Suitable acid chlorides can include, for example, acetyl chloride, propionyl chloride, butyryl chloride, benzoyl chloride and like acid chlorides. Suitable anhydrides can include, for example, acetic anhydride, propionic anhydride, butyric anhydride, benzoic anhydride and like anhydrides. Mixtures of these anhydrides or other acetylating agents can also be used in order to introduce differing acyl groups to the cellulose. Mixed anhydrides such as, for example, acetic propionic anhydride, acetic butyric anhydride and the like can also be used for this purpose in some embodiments.

In most cases, the cellulose is exhaustively acetylated with the acetylating agent to produce a derivatized cellulose having a high degree of substitution (DS) value, such as from 2.4 to 3, along with some additional hydroxyl group substitution (e.g., sulfate esters) in some cases. Exhaustively acetylating the cellulose refers to an acetylation reaction that is driven toward completion such that as many hydroxyl groups as possible in cellulose undergo an acetylation reaction.

Suitable acidic catalysts for promoting the acetylation of cellulose often contain sulfuric acid or a mixture of sulfuric acid and at least one other acid. Other acidic catalysts not containing sulfuric acid can similarly be used to promote the acetylation reaction. In the case of sulfuric acid, at least some of the hydroxyl groups in the cellulose can become initially functionalized as sulfate esters during the acetylation reaction. Once exhaustively acetylated, the cellulose is then subjected to a controlled partial de-esterification step, generally in the presence of a de-esterification agent, also referred to as a controlled partial hydrolysis step.

De-esterification, as used herein, refers to a chemical reaction during which one or more of the ester groups of the intermediate cellulosic ester are cleaved from the cellulose acetate and replaced with a hydroxyl group, resulting in a cellulose acetate product having a (second) DS of less than 3. “De-esterifying agent,” as used herein, refers to a chemical agent capable of reacting with one or more of the ester groups of the cellulose acetate to form hydroxyl groups on the intermediate cellulosic ester. Suitable de-esterifying agents include low molecular weight alcohols, such as methanol, ethanol, isopropyl alcohol, pentanol, R—OH, wherein R is C1 to C20 alkyl group, and mixtures thereof. Water and a mixture of water and methanol may also be used as the de-esterifying agent. Typically, most of these sulfate esters are cleaved during the controlled partial hydrolysis used to reduce the amount of acetyl substitution. The reduced degree of substitution may range from 0.5 to 3.0, e.g., from 1.3 to 3, from 1.3 to 2.9, from 1.5 to 2.9 or from 2 to 2.6. For purposes of this disclosure, the degree of substitution is typically from 1.3 to 2.9 since below 1.3, natural degradation may occur. The degree of substitution may be selected based on the at least one organic solvent to be used in the binder composition. For example, when acetone is used as the organic solvent, the degree of substitution may range from 2.2 to 2.65.

The number average molecular weight of the cellulose ester may range from 30,000 Daltons (Da) to 100,000 Da, e.g., from 50,000 Da to 80,000 Da and may have a polydispersity from 1.5 to 2.5, e.g., from 1.75 to 2.25 or from 1.8 to 2.2. All molecular weight recited herein, unless otherwise specified, are number average molecular weights. The molecular weight may be selected based on the desired hardness of the final tow or filter rod. Although greater molecular weight leads to increased hardness, greater molecular weight also increases viscosity. The cellulose ester may be provided in powder or flake form.

In some aspects, blends of different molecular weight cellulose ester flake or powder may be used. Accordingly, a blend of high molecular weight cellulose ester, e.g., a cellulose ester having a molecular weight above 60,000 Da, may be blended with a low molecular weight cellulose ester, e.g., a cellulose ester having a molecular weight below 60,000 Da. The ratio of high molecular weight cellulose ester to low molecular weight cellulose ester may vary but may generally range from 1:10 to 10:1; e.g., from 1:5 to 5:1 or from 1:3 to 3:1. Blends of different cellulose esters may also be used and may include two, three, four, or more different cellulose esters in varied ratios. In some aspects, one cellulose ester may be present in a majority while other cellulose esters are present in smaller amounts.

### V. CELLULOSE ACETATE FIBERS, TOW, AND TOW BALES

There are a number of methods of forming fibers from cellulose acetate which may be employed to form the cellulose acetate fibers of the present disclosure. In some embodiments, to form fibers from cellulose ester, a dope is formed by dissolving the cellulose ester in a solvent to form a dope solution. The dope solution is typically a highly viscous solution. The solvent of the dope solution may be selected from the group consisting of water, acetone, methylethyl ketone, methylene chloride, dioxane, dimethyl formamide, methanol, ethanol, glacial acetic acid, supercritical carbon dioxide, any suitable solvent capable of dissolving the aforementioned polymers, and combinations thereof. In some aspects, the solvent is acetone or a combination of acetone and up to 5 wt. % water. Pigments may also be added to the dope. The dope may comprise, for example, from 10 to 40 wt. % cellulose acetate and from 60 to 90 wt. % solvent. Pigments, when added, may be present from 0.1 to 5 wt. %, e.g., from 0.1 to 4 wt. %, from 0.1 to 3 wt. % from 0.1 to 2 wt. %, from 0.5 to 5 wt. %, from 0.5 to 4 wt. %, from 0.5 to 3 wt. %, from 0.5 to 2 wt. %, from 1 to 5 wt. %, from 1 to 4 wt. %, from 1 to 3 wt. % or from 1 to 2 wt. %. The dope is then filtered and deaerated prior to being spun to form fibers. The dope may be spun in a spinner comprising one or more cabinets, each cabinet comprising a spinneret. The spinneret comprises holes that affect the rate at which the solvent evaporates from the fibers.

The pigment added to the dope is not particularly limited, and any conventional pigment may be used. Examples of common, suitable pigments include calcium carbonate, diatomaceous earth, magnesium oxide, zinc oxide, and barium sulfate.

Generally, the production of a bale of tow bands may involve spinning fibers from the dope, forming a tow band from the fibers, crimping the tow band, and baling the crimped tow band. Within said production, optional steps may include, but are not limited to, warming the fibers after spinning, applying a finish or additive to the fibers and/or tow band prior to crimping, and conditioning the crimped tow band. The parameters of at least these steps are important for producing desirable bales.

It should be noted that bales may vary in size and shape as needed for further processing. In some embodiments, bales may have dimensions ranging from 30 inches (76 cm) to 60 inches (152 cm) in height, 46 inches (117 cm) to 56 inches (142 cm) in length, and 35 inches (89 cm) to 45 inches (114 cm) in width. In some embodiments, bales may range in weight from 900 pounds (408 kg) to 2100 pounds (953 kg). In some embodiments, bales may have a density greater than 300 kg/m3 (18.8 lb/ft3).

Fibers

The structure of the cellulose acetate fibers for use in the present disclosure is not particularly limited, and various known fiber structures may be employed. For example, the tow band may utilize fibers having a broad range of denier per filament (dpf). In some embodiments, the cellulose acetate fibers (e.g., fibers in a tow band) has from 1 to 30 dpf, e.g., from 1.1 to 25 dpf, from 1.2 to 20 dpf, from 1.4 to 15 dpf, from 1.5 to 10 dpf, from 1.8 to 9 dpf, from 1.9 to 8 dpf, from 1.8 to 6 dpf, from 1.9 to 4 dpf, from 1.9 to 3.5 dpf, from 1.9 to 3 dpf, from 2 to 3 dpf, from 2.1 to 2.9 dpf, from 2.1 to 2.8 dpf, from 2.2 to 2.7 dpf, from 2.5 to 2.8 dpf, from 2.6 to 3.0 dpf, from 2.3 to 2.5 dpf, from 2.0 to 2.2 dpf, or from 2.6 to 2.8 dpf.

In some embodiments, the cellulose acetate fibers are sub-micron fibers. In some embodiments, the sub-micron cellulose acetate fibers have from 0.1 to 1 dpf, e.g., from 0.1 to 0.9 dpf, from 0.2 to 0.9 dpf, from 0.3 to 0.8 dpf, from 0.4 to 0.8 dpf, from 0.4 to 0.7 dpf, from 0.4 to 0.6 dpf, from 0.1 to 0.5 dpf, or from 0.2 to 0.4 dpf.

The fibers for use in the present disclosure may have any suitable cross-sectional shape, including, but not limited to, circular, substantially circular, crenulated, ovular, substantially ovular, polygonal, substantially polygonal, dog-bone, “Y,” “X,” “K,” “C,” multi-lobe, and any hybrid thereof. As used herein, the term “multi-lobe” refers to a cross-sectional shape having a point (not necessarily in the center of the cross-section) from which at least two lobes extend (not necessarily evenly spaced or evenly sized).

As noted above, fibers for use in the present disclosure may be produced by any method known to one skilled in the art. As noted, in some embodiments, fibers may be produced by spinning a dope through a spinneret. As used herein, the term “dope” refers to a cellulose acetate solution and/or suspension from which fibers are produced. In some embodiments, a dope may comprise cellulose acetate and solvents. In some embodiments, a dope for use in conjunction with the present disclosure may comprise cellulose acetate, solvents, and additives. In some embodiments, the cellulose acetate may be at a concentration in the dope ranging from 10 to 40 wt. % (e.g., from 20 to 30 wt. %, from 25 to 40 wt. %, from 25 to 30 wt. %), and the solvent may be at a concentration from 60 to 90 wt. % (e.g., 60 to 80 wt. %, 70 to 80 wt. %, 80 to 90 wt. %). In some embodiments, the dope may be heated to a temperature ranging from 40° C. to 100° C. (e.g., from 45° C. to 95° C., from 50° C. to 90° C., from 55° C. to 85° C., from 60° C. to 80° C.).

Suitable solvents may include, but not be limited to, water, acetone, methylethyl ketone, methylene chloride, dioxane, dimethyl formamide, methanol, ethanol, glacial acetic acid, supercritical CO2, any suitable solvent capable of dissolving the aforementioned polymers, or any combination thereof. By way of nonlimiting example, a solvent for cellulose acetate may be an acetone/methanol mixture. In some embodiments, to produce very high dpf values of the present disclosure, increased solvent levels compared with amounts for typical dpf values (e.g., 2 to 8 dpf) may be used. For example in some embodiments, to produce very high dpf tow, solvent amounts may be from 5 to 30 wt. % greater when compared with solvent amounts for typical dpf tow. Additional solvent amounts may, in some cases, present challenges to the processing of the fibers.

Some embodiments of the present disclosure may involve treating fibers to achieve surface functionality on the fibers. In some embodiments, fibers may comprise a surface functionality including, but not limited to, biodegradability sites (e.g., defect sites to increase surface area to enhance biodegradability), chemical handles (e.g., carboxylic acid groups for subsequent functionalization), active particle binding sites (e.g., sulfide sites binding gold particles or chelating groups for binding iron oxide particles), sulfur moieties, or any combination thereof. One skilled in the art should understand the plurality of methods and mechanisms to achieve surface functionalities. Some embodiments may involve dipping, spraying, ionizing, functionalizing, acidizing, hydrolyzing, exposing to a plasma, exposing to an ionized gas, or any combination thereof to achieve surface functionalities. Suitable chemicals to impart a surface functionality may be any chemical or collection of chemicals capable of reacting with cellulose acetate including, but not limited to, acids (e.g., sulfuric acid, nitric acid, acetic acid, hydrofluoric acid, hydrochloric acid, and the like), reducing agents (e.g., LiAlH₄, NaBH₄, H2/Pt, and the like), Grignard reagents (e.g., CH₃MgBr, and the like), trans-esterification reagent, amines (e.g., R—NH₃ like CH₃NH₃), or any combination thereof. Exposure to plasmas and/or ionized gases may react with the surface, produce defects in the surface, or any combination thereof. Said defects may increase the surface area of the fibers which may yield higher loading and/or higher filtration efficacy in the final filter products.

Some embodiments of the present disclosure may involve applying a finish to the fibers. Suitable finishes may include, but not be limited to, at least one of the following: oils (e.g., mineral oils or liquid petroleum derivatives), water, additives, antimicrobials or any combination thereof. Examples of suitable mineral oils may include, but not be limited to, water white (i.e., clear) mineral oil having a viscosity of 80-95 SUS (Sabolt Universal Seconds) measured at 38° C. Examples of suitable emulsifiers may include, but not be limited to, sorbitan monolaurate, e.g., SPAN® 20 (available from Croda, Wilmington, Del.), poly(ethylene oxide) sorbitan monolaurate, e.g., TWEEN® 20 (available from Croda, Wilmington, Del.). The water may be de-mineralized water, de-ionized water, or otherwise appropriately filtered and treated water. The lubricant or finish may be applied by spraying or wiping. Generally, the lubricant or finish is added to the fiber prior to forming the fibers into tow.

In some embodiments of the present disclosure, finish may be applied as a neat finish or as a finish emulsion in water. As used herein, the term “neat finish” refers to a finish formulation without the addition of excess water. It should be noted that finish formulations may comprise water. In some embodiments, finish may be applied neat followed by applying water separately.

In some embodiments of the present disclosure, a finished emulsion may comprise less than 98% water, less than 95%, less than 92%, or less than 85%. In some embodiments, it may be advantageous in later steps to have fibers having a lower weight percentage of moisture (e.g., 5% to 25% w/w of the tow band), of which water is a contributor. The water content of the finished emulsion may be at least one parameter that may assist in achieving said weight percentage of moisture in the fibers. Therefore, in some embodiments, a finished emulsion may comprise less than 92% water, less than 85% water, or less than 75% water.

Tow

The present disclosure includes forming tow bands from a plurality of fibers. In some embodiments, the tow band is from 10,000 to 100,000 total denier, e.g., from 15,000 to 100,000, from 20,000 to 100,000, from 25,000 to 100,000, from 30,000 to 100,000, from 10,000 to 90,000, from 15,000 to 90,000, from 20,000 to 90,000, from 25,000 to 90,000, from 30,000 to 90,000, from 10,000 to 90,000, from 15,000 to 90,000, from 20,000 to 90,000, from 25,000 to 90,000, from 30,000 to 90,000, from 10,000 to 80,000, from 15,000 to 80,000, from 20,000 to 80,000, from 25,000 to 80,000, from 30,000 to 80,000, from 10,000 to 70,000, from 15,000 to 70,000, from 20,000 to 70,000, from 25,000 to 70,000, from 25,000 to 30,000, from 30,000 to 70,000, from 10,000 to 60,000, from 15,000 to 60,000, from 20,000 to 60,000, from 25,000 to 60,000, from 25,000 to 45,000, from 28,000 to 45,000, or from 30,000 to 45,000. In terms of upper limits, the tow band may be less than 100,000 total denier, e.g., less than 90,000, less than 80,000, less than 70,000, or less than 60,000. In terms of lower limits, the tow band may be greater than 10,000 total denier, e.g., greater than 15,000, greater than 20,000, greater than 22,000, or greater than 25,000.

In some embodiments, the cellulose acetate tow may comprise a filament count from 10,000 filaments to 50,000 filaments, e.g., from 12,000 filaments to 25,000 filaments, from 13,000 filaments to 23,000 filaments, from 15,000 filaments to 22,000 filaments, from 16,000 filaments to 21,000 filaments, from 15,000 filaments to 25,000 filaments, or from 16,000 filaments to 20,000 filaments. In terms of upper limits, the cellulose acetate tow may comprise a filament count less than 50,000 filaments, e.g., less than 45,000, less than 40,000, less than 35,000, or less than 30,000. In terms of lower limits, the cellulose acetate tow may comprise a filament count greater than 10,000 filaments, e.g., greater than 12,000, greater than 14,000, greater than 16,000, or greater than 18,000.

In some embodiments, the tow can have a breaking strength between 3.5 kg and 25 kg, e.g. from 3.5 kg to 22.5 kg, from 3.5 kg to 20 kg, from 3.5 kg to 17.5 kg, from 3.5 kg to 15 kg, from 4 kg to 25 kg, from 4 kg to 22.5 kg, from 4 kg to 20 kg, from 4 kg to 17.5 kg, from 4 kg to 15 kg, from 4.5 kg to 25 kg, from 4.5 kg to 22.5 kg, from 4.5 kg to 20 kg, from 4.5 kg to 17.5 kg, from 4.5 kg to 15 kg, from 5 kg to 25 kg, from 5 kg to 22.5 kg, from 5 kg to 20 kg, from 5 kg to 17.5 kg, or from 5 kg to 15 kg. In terms of upper limits, the tow may have a breaking strength of less than 25 kg, e.g., less than 22.5 kg, less than 20 kg, less than 17.5 kg, or less than 15 kg. In terms of lower limits, the tow may have a breaking strength of greater than 3.5 kg, e.g. greater than 4 kg, greater than 4.5 kg, or greater than 5 kg.

In some embodiments of the present disclosure, a tow band may comprise more than one type of fiber. In some embodiments, the more than one type of fiber may vary based on dpf, cross-sectional shape, composition, treatment prior to forming the tow band, or any combination thereof. Examples of suitable additional fibers may include, but are not limited to, carbon fibers, activated carbon fibers, natural fibers, synthetic fibers, or any combination thereof.

Some embodiments of the present disclosure may include crimping the tow band to form a crimped tow band. Crimping the tow band may involve using any suitable crimping technique known to those skilled in the art. These techniques may include a variety of apparatuses including, but not limited to, a stuffer box or a gear. Nonlimiting examples of crimping apparatuses and the mechanisms by which they work can be found in U.S. Pat. Nos. 7,610,852 and 7,585,441, the entire contents and disclosures of which are incorporated herein by reference. Suitable stuffer box crimpers may have smooth crimper nip rolls, threaded or grooved crimper nip rolls, textured crimper nip rolls, upper flaps, lower flaps, or any combination thereof.

The configuration of the crimp may play a role in the processability of the final bale. Examples of crimp configurations may include, but not be limited to, lateral, vertical, some degree between lateral and vertical, random, or any combination thereof. As used herein, the term “lateral” when describing crimp orientation refers to crimp or fiber bends in the plane of the tow band. As used herein, the term “vertical” when describing a crimp orientation refers to crimp projecting outside of the plane of the tow band and perpendicular to the plane of the tow band. It should be noted that the terms lateral and vertical refer to general overall crimp orientation and may have deviation from said configuration by +/−30 degrees.

In some embodiments of the present disclosure, a crimped tow band may comprise fibers with a first crimp configuration and fibers with a second crimp configuration.

In some embodiments of the present disclosure, a crimped tow band may comprise fibers with at least a vertical crimp configuration near the edges and fibers with at least a lateral crimp configuration near the center. In some embodiments, a crimped tow band may comprise fibers with a vertical crimp configuration near the edges and fibers with a lateral crimp configuration near the center.

The configuration of the crimp may be important for the processability of the final bale in subsequent processing steps, e.g., a lateral crimp configuration may provide better cohesion of fibers than a vertical crimp configuration unless further steps are taken to enhance cohesion. Methods for crimping tow bands with a substantially later crimp configuration are disclosed, for example, in U.S. Pub. No. 2013/0115452 and U.S. Pub. No. 2015/0128964, each of which is incorporated herein in its entirety.

In some embodiments of the present disclosure, the fibers may be adhered to each other to provide better processability of the final bale. While adhesion additives may be used in conjunction with any crimp configuration, it may be advantageous to use adhesion additives with a vertical crimp configuration. In some embodiments, adhering may involve adhesion additives on and/or in the fibers. Examples of such adhesion additives may include, but not be limited to, binders, adhesives, resins, tackifiers, or any combination thereof. It should be noted that any additive described herein, or otherwise, capable of adhering two fibers together may be used, which may include, but not be limited to, active particles, active compounds, ionic resins, zeolites, nanoparticles, ceramic particles, softening agents, plasticizers, pigments, dyes, flavorants, aromas, controlled release vesicles, surface modification agents, lubricating agents, emulsifiers, vitamins, peroxides, biocides, antifungals, antimicrobials, antistatic agents, flame retardants, antifoaming agents, degradation agents, conductivity modifying agents, stabilizing agents, or any combination thereof. Some embodiments of the present disclosure may involve adding adhesive additives to the fibers (in, on, or both) by incorporating the adhesive additives into the dope, incorporating the adhesive additives into the finish, applying the adhesive additives to the fibers (before, after, and/or during forming the tow band), applying the adhesive additives to the tow band (before, after, and/or during crimping), or any combination thereof.

Adhesive additives may be included in and/or on the fibers at a concentration sufficient to adhere the fibers together at a plurality of contact points to provide better processability of the final bale. The concentration of adhesive additives to use may depend on the type of adhesive additive and the strength of adhesion the adhesive additive provides. In some embodiments, the concentration of adhesive additive may range from a lower limit of 0.01%, 0.05%, 0.1%, or 0.25% to an upper limit of 5%, 2.5%, 1%, or 0.5% by weight of the tow band in the final bale. It should be noted that for additives that are used for more than adhesion, the concentration in the tow band in the final bale may be higher, e.g., 25% or less.

Further, some embodiments of the present disclosure may involve heating the fibers before, after, and/or during crimping. While said heating may be used in conjunction with any crimp configuration, it may be advantageous to use said heating with a vertical crimp configuration. Said heating may involve exposing the fibers of the tow band to steam, aerosolized compounds (e.g., plasticizers), liquids, heated fluids, direct heat sources, indirect heat sources, irradiation sources that causes additives in the fibers (e.g., nanoparticles) to produce heat, or any combination thereof.

Some embodiments of the present disclosure may include conditioning the crimped tow band. Conditioning may be used to achieve a crimped tow band having a residual acetone content of 0.5% or less w/w of the crimped tow band. Conditioning may be used to achieve a crimped tow band having a residual water content of 8% or less w/w of the crimped tow band. Conditioning may involve exposing the fibers of the crimped tow band to steam, aerosolized compounds (e.g., plasticizers), liquids, heated fluids, direct heat sources, indirect heat sources, irradiation sources that causes additives in the fibers (e.g., nanoparticles) to produce heat, or any combination thereof.

UCE is the amount of work required to uncrimp a fiber. UCE, as reported hereinafter, is sampled prior to baling, i.e., post-drying and pre-baling. UCE, as used herein, is measured as follows: using a warmed up (20 minutes before conventional calibration) Instron tensile tester (Model 1130, crosshead gears—Gear #'s R1940-1 and R940-2, Instron Series IX-Version 6 data acquisition & analysis software, Instron 50 Kg maximum capacity load cell, Instron top roller assembly, 1″×4″×⅛″ thick high grade Buna-N 70 Shore A durometer rubber grip faces), a preconditioned tow sample (preconditioned for 24 hours at 22° C.±2° C. and Relative humidity at 60%±2%) of about 76 cm in length is looped over and spread evenly across the center of the top roller, pre-tensioned by gently pulling to 100 g±2 g (per readout display), and each end of the sample is clamped (at the highest available pressure, but not exceeding the manufacturers recommendations) in the lower grips to effect a 50 cm gauge length (gauge length measured from top of the robber grips), and then tested, until break, at a crosshead speed of 30 cm/minute. This test is repeated until three acceptable tests are obtained and the average of the three data points from these tests is reported. Energy (E) limits are between 0.220 kg and 10.0 kg. Displacement (D) has a preset point of 10.0 kg. UCE is calculated by the formula: UCE (gcm/cm)=(E*1000)/((D*2)+500). Breaking strength can be calculated using the same test and the following equation BS=L (where L is the load at max load (kg)). In certain embodiments of the disclosure, UCE values (in gcm/cm) can range from 190 to 400, e.g., 200 to 300, e.g., 290. In certain embodiments of the disclosure breaking strength can range from between 3.5 kg and 25 kg, e.g. 4 kg to 20 kg, 4.5 kg to 15 kg, or 5 kg to 12 kg.

In some embodiments, the cellulose acetate may be non-woven. The non-woven cellulose acetate may be a manufactured sheet, batting, webbing, or fabric that is held together by various methods. Those methods include, for example, fusion of fibers (e.g., thermal, ultrasonic, pressure, and the like), bonding of fibers (e.g., resins, solvents, adhesives, and the like), and mechanical entangling (e.g., needle-punching, entangling, and the like). In some embodiments, the cellulose acetate includes fibrous structures made by dry, wet, or air-laying processes. In some embodiments, the non-woven cellulose acetate may also broadly cover other structures such as those held together by interlacing of yarns (stitch bonding) or those made from perforated or porous films.

In some embodiments, the cellulose acetate includes fibrous structures made by such processes as dry, wet, or air-laying (with or without one of the methods of holding the fibers together mentioned above), needle-punching, spunbond or meltblown processes, electro-spin processes, and hydroentangling (spunlacing). In the dry, wet, air-laying, and hydroentangling (spunlacing) processes, staple fibers are used in the manufacture of the nonwoven material. In some aspects, the wet and air-laying processes do not require any plasticizer. In the spunbond and meltblown processes, molten polymer is extruded onto a moving belt; the fibers of these types of nonwovens may be filaments. In some embodiments, the cellulose acetate may be woven, knitted, and tufted structures, paper, and felts made by wet milling processes. In some embodiments, a combination of different cellulose acetate fibers may be used to produce the filter structure. For example, one or more of staple fibers, electro-spun fibers, and melt-spun fibers can be used in combination with cellulose acetate tow.

In some embodiments, the cellulose acetate includes sub-micron fibers made by any of the aforementioned processes. For example, the sub-micron fibers can be made by electrospinning, force spinning, or solvent spinning.

In some embodiments, the cellulose acetate tow may be further processed according the processes described in U.S. Pat. Nos. 8,416,066 and 9,297,099, the entireties of which are incorporated by reference. For example, the cellulose acetate tow may be further processed using one or more of the following processes. The cellulose acetate tow may be pulled from a tow bale.

The tow (or tow band) may be spread (i.e., increasing its width from the compressed state in the bale) by use of one or more banding jets (e.g., air banding jet). During travel, the tow may be guided by one or more guides. In some embodiments, multiple tows may be combined by feeding several tow bands together. In this way, the nonwoven may include differing fibers. Differing fibers may include, but is not limited to, fibers of differing sizes, fibers made of differing materials, fibers having differing additives or surface coatings, fibers of differing chemical, medical, and physical properties, and combinations thereof.

The crimp in the spread tow is then deregistered in deregistering apparatus that may consist of at least two pairs of driven rollers, for example, three pairs of rollers. In some embodiments, one roller of each pair is grooved or threaded and the mate is smooth. Additionally, a pair of pretension rollers may be used to facilitate deregistration of the filaments of the tow band. Fixing the 3-dimensional structure of the bulked tow may be accomplished before, during, or after the tow is bulked or calendered.

In some embodiments, a plasticizer (e.g., triacetin) is added to the deregistered tow prior to bulking to facilitate fixing of the 3-dimensional structure of the nonwoven fabric. The plasticizer may be added in any conventional manner. Application of the plasticizer may be by brushing, spraying, spray brushing, pads, wicks, or other types of plasticizer applicators. Further, the plasticizer may be applied to one or more sides of the tow/bulked tow. For example, the plasticizer can be directly applied to the surface(s) (e.g., top and bottom surfaces). Optionally, when the plasticizer method of fixing is used, setting of the fixing may be sped up, i.e., reducing the set time. Speeding up the set may be accomplished in any conventional manner. In some embodiments, setting may be sped up by the injection of live steam into the bulked tow. The injection of steam may be further aided by a pair of nip rollers which additionally serve to control the thickness and density of the nonwoven fabric. Alternatively, a pair of heated godet rollers may be used to set the fix. These heated godet rollers contact the bulked tow and not only help set the 3-dimensional structure of the tow, but also control the thickness and density of the nonwoven fabric.

The deregistered tow is bulked in any conventional manner. In one embodiment, the tow is bulked with an air jet. Such air jets are known. See, for example, U.S. Pat. Nos. 5,331,976 and 6,253,431, incorporated herein by reference. After bulking and before fixing, it may be necessary to carry the bulked tow because the bulked tow has little to no machine direction (MD) strength. For example, the bulked tow may be carried on: a discrete material (e.g., a tissue) or moving belt or a rotating drum (which may or may not be vacuum assisted). The tissue may be subsequently discarded or the tissue may be incorporated into a subsequent product based upon the nonwoven material. Additionally, the tissue may sandwich the bulked tow. By sandwiching the tow, the bulked tow would have the same characteristic on both sides. Tissue, as used here, includes, but is not limited to: tissue, woven fabric, knitted fabric, other nonwoven, same nonwoven, film or the like. Alternatively, a single, pair, or more than one roller (or set of opposed rollers) can be used to transport the web prior to fixing. Additional operating parameters of the foregoing process may be obtained from the relevant portions of U.S. Pat. Nos. 6,253,431; 6,543,106; 6,983,520; 7,059,027; 7,076,848; 7,103,946; 7,107,659; and 7,181,817; each of which is incorporated herein by reference.

After the bulked tow is fixed, it is ready for calendering. In calendering, the bulked tow is passed through the nip (i.e., gap) of a pair of heated rollers. In some embodiments, the temperature of the heated rollers (e.g., top roller and bottom roller) can be greater than 65° C., e.g., greater than 70° C., greater than 75° C., greater than 80° C., greater than 85° C., greater than 90° C., greater than 95° C., greater than 100° C., greater than 105° C., greater than 110° C., greater than 115° C., greater than 120° C., or greater than 130° C. The temperature of the heated rollers can impact the structural integrity of the cellulose acetate tow. Additionally, calendering can be impacted by overfeed. Nip and temperature are also important, but without overfeed, the instant nonwoven will not be formed. (It is understood that composition of filament, line speed, binder/plasticizer, tow overfeed, thermal transfer, and the like also influence, to an extent, calendering and the material produced). Overfeed is the ratio of the linear speed of the tow entering the air jet to the linear speed of the bulked tow through the nip. Overfeed, at minimum, is about 1.5-2.0:1, and, at maximum, there is no theoretical limit, but the practical limit is about 16:1. For a nonwoven material made from cellulose acetate filaments (one embodiment of the instant invention): the nip may range from about 0-10 mm (alternatively 0-5 mm, or 0-3 mm); and the temperature may range from about 148.8 to 204.4° C. If both rolls are heated, the fixing and densification of the surface portion is accomplished on both external surfaces of the nonwoven material. If only one of the rolls is heated, the densification of the surface portion is accomplished only on the external surface in contact with the heated roll, with heat transfer through the structure assisting in fixing of the nonwoven.

After the bulked tow is calendered, it is ready for optional subsequent processing. Subsequent processing may include, but is not limited to: wind-up; addition of other material or components; sterilization; cutting to shape; packaging; subsequent bonding (e.g., external energy source or adhesives); and combinations thereof. The instant nonwoven fabric may also be joined to one or more other substrates. Such substrates include, but are not limited to, films, meshes, nonwovens, or fabrics (woven or knitted).

### VI. PLASTICIZER

In some embodiments, a plasticizer may be added to the cellulose acetate tow to fix the fibers together. Additionally, the plasticizer aids in degradation of cellulose acetate tow. In some embodiments, the plasticizer maybe present from 0.5 to 30 wt. % based on the total weight of the cellulose acetate tow, e.g., from 1 to 35 wt. %, from 1 to 35 wt. %, from 1 to 35 wt. %, from 1 to 35 wt. %, from 1 to 35 wt. %, from 1 to 35 wt. %, from 5 to 30 wt. %, or from 10 to 25 wt. %. The percentage of plasticizer may vary depending on the method by which the cellulose acetate tow is formed. In some embodiments, a ratio of the cellulose acetate tow to plasticizer is from 100:1 to 3:1, e.g., from 90:1 to 4:1, from 80:1 to 5:1, from 75:1 to 10:1, from 70:1 to 15:1, from 60:1 to 20:1, from 50:1 to 25:1, or from 45:1 to 30:1. An advantage to the inclusion of a plasticizer is the time needed to degrade the cellulose acetate tow. By including a plasticizer in the specific amounts described herein, the plasticizer aids in deacetylating the cellulose acetate tow or cellulose ester, when exposed to water.

In some embodiments, a wide variety of plasticizers known for plasticizing cellulose acetate tow can be used. In some embodiments, the plasticizer is at least one plasticizer selected from triacetin, trimethyl phosphate, triethyl phosphate, tributyl phosphate, triphenyl phosphate, triethyl citrate, acetyl trimethyl citrate, acetyl triethyl citrate, acetyl tributyl citrate, tributyl-o-acetyl citrate, dibutyl phthalate, diaryl phthalate, diethyl phthalate, dimethyl phthalate, di-2-methoxyethyl phthalate, di-octyl phthalate, di-octyl adipate, dibutyl tartrate, ethyl o-benzoylbenzoate, ethyl phthalyl ethyl glycolate, methyl phthalyl ethyl glycolate, n-ethyltoluenesulfonamide, o-cresyl p-toluenesulfonate, ethylene glycol, diethylene glycol, 1,2-propylene glycol, 1,3-propylene glycol, 1,2-butylene glycol, 1,3-butylene glycol, 1,4-butylene glycol, neopentyl glycol, 1,5-pentanediol, 1,6 hexanediol, 1,5-pentylene glycol, triethylene glycol, and tetraethylene glycol, aromatic diol, substituted aromatic diols, aromatic ethers, tripropionin, tribenzoin, polycaprolactone, glycerin, glycerin esters, diacetin, propylene glycol dibenzoate, glyceryl tribenzoate, diethylene glycol dibenzoate, triethylene glycol dibenzoate, di propylene glycol dibenzoate, and polyethylene glycol dibenzoate, glycerol acetate benzoate, stearyl alcohol, lauryl alcohol, phenol, benzyl alcohol, hydroquinone, catechol, resorcinol, ethylene glycol, neopentyl glycol, 1,4-cyclohexanedimethanol, diethylene glycol, polyethylene glycol, polyethylene glycol esters, polyethylene glycol diesters, di-2-ethylhexyl polyethylene glycol ester, triethylene glycol bis-2-ethyl hexanoate, glycerol esters, diethylene glycol, polypropylene glycol, polyglycoldiglycidyl ethers, dimethyl sulfoxide, N-methyl pyrollidinone, C1-C20 dicarboxylic acid esters, dimethyl adipate, di-butyl maleate, di-octyl maleate, resorcinol monoacetate, catechol, catechol esters, phenols, epoxidized soy bean oil, castor oil, linseed oil, epoxidized linseed oil, other vegetable oils, other seed oils, difunctional glycidyl ether based on polyethylene glycol, γ-valerolactone, alkylphosphate esters, aryl phosphate esters, phospholipids, eugenol, cinnamyl alcohol, camphor, methoxy hydroxy acetophenone, vanillin, ethylvanillin, 2-phenoxyethanol, glycol ethers, glycol esters, glycol ester ethers, polyglycol ethers, polyglycol esters, ethylene glycol ethers, propylene glycol ethers, ethylene glycol esters, propylene glycol esters, polypropylene glycol esters, acetylsalicylic acid, acetaminophen, naproxen, imidazole, triethanol amine, benzoic acid, benzyl benzoate, salicylic acid, 4-hydroxybenzoic acid, propyl-4-hydroxybenzoate, methyl-4-hydroxybenzoate, ethyl-4-hydroxybenzoate, benzyl-4-hydroxybenzoate, diethylene glycol dibenzoate, dipropylene glycol dibenozoate, triethylene glycol dibenzoate, butylated hydroxytoluene, butylated hydroxyanisol, sorbitol, xylitol, ethylene diamine, piperidine, piperazine, hexamethylene diamine, triazine, triazole, pyrrole, and mixtures thereof.

In some embodiments, the plasticizer is a food grade plasticizer. As used herein, the term “food grade” refers to a material that has been approved for contacting (directly or indirectly) food, which may be classified as based on the material's conformity to the requirements of the United States Pharmacopeia (“USP-grade”), the National Formulary (“NF-grade”), and/or the Food Chemicals Codex (“FCC-grade”) as of Apr. 30, 2017. In some embodiments, food grade plasticizers may include triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, and combinations thereof. In further embodiments, the plasticizer is triacetin.

In some embodiments, the cellulose acetate tow may optionally comprise a processing aid. When included, the processing aid may be present in an amount from 0.05 to 10 wt. % based on the total weight of the cellulose acetate tow, e.g., from 0.1 to 5 wt. %, or from 0.5 to 2.5 wt. %. The processing aid may be selected from the group consisting of titanium dioxide, aluminum oxide, zirconium oxide, silicon dioxide, calcium carbonate, calcium silicate, aluminum silicate, magnesium silicate, calcium phosphate and mixtures thereof. In some embodiments, the processing aid is silica. The average particle size of the processing aid may vary. In some aspects, the processing aid may have an average particle size from 0.01 to 50 μm, e.g., from 0.02 microns to 40 microns, from, from 0.05 microns to 30 microns. The particle size may be determined, for example, by sieve analysis.

In some embodiments, a releasing agent may also be included in order to improve releasability of the cellulose acetate tow, once formed, from a backing sheet or substrate. When included, the releasing agent may be present from 0.01 to 10 wt. % based on the total weight of the cellulose acetate tow, e.g., from 0.05 to 5 wt. %, from 0.05 to 1 wt. %, or from 0.05 to 0.5 wt. %. The releasing agent is generally included when the cellulose acetate tow is solvent cast, and is added to the dope. In some embodiments, the releasing agent is a fatty acid, such as stearic acid.

In some embodiments, a plasticizer is added to the cellulose acetate tow. The plasticizer may be added in any conventional manner. Application of the plasticizer may be by brushing, spraying, spray brushing, pads, wicks, or other types of plasticizer applicators. Further, the plasticizer may be applied to one or more sides of the tow/bulked tow. For example, the plasticizer (e.g.) can be directly applied to the surface(s) (e.g., top and bottom surfaces). In some embodiments, plasticizer is sprayed (e.g., a nozzle) onto a top surface or bottom surface of the cellulose acetate tow. In this embodiment, the amount of plasticizer applied to the surface may be controlled by the pump of the spray nozzle. In some embodiments, plasticizer is spray brushed (e.g., a roller brush) onto a top surface or bottom surface of the cellulose acetate tow. A roller brush may be submerged in a bath comprising plasticizer (e.g., triacetin) and is operated at a roller speed to spray the plasticizer to the surface of the cellulose acetate tow. In this embodiment, the amount of plasticizer applied to the surface may be controlled by the rotational speed of the roller brush. After the plasticizer is applied to the surface(s) the cellulose acetate tow, the cellulose acetate tow can be processed through an air jet, for example, as described in U.S. Pat. Nos. 5,331,976 and 6,253,431, to bulk (e.g., spread and open) the cellulose acetate tow. In some embodiments, the bulked cellulose acetate tow can be calendered by a pair of heated rollers. The temperature of the heated roller is an important parameter to control the properties of the resulting filter structure (e.g., air permeability). Additionally, the feed (e.g., the amount of cellulose acetate tow fed to the rollers) into the heated rollers can serve to control the thickness and density of the filter structure.

### VII. METHODS OF USE

In some embodiments, the present filter structures described herein are designed to prevent or reduce the passage of airborne pathogens and particulates. For example, the filter structure may be designed to remove solid particulates, such as dust, pollen, or mold, from the air as well as pathogens, such as bacteria or viruses. The filter structures described herein can be used in any protective covering to protect a user from inhaling airborne pathogens and particulates (e.g., through the mouth or nose). Numerous applications utilize filter structures other than protective coverings described herein. For example, a filter structure may be utilized as an air filter, e.g., in a high efficiency particulate air (HEPA) filter, a heating unit, ventilation, and air conditioning (HVAC) filter, or an automotive cabin filter.

The present disclosure will be better understood in view of the following non-limiting examples.

### EXAMPLES

### Example 1

In order to determine the properties of the filter structure, multiple different cellulose acetate tow fibers and processing methods were tested. After the cellulose acetate tow was produced according to the processes described herein, the cellulose acetate tow was further processed to produce the filter structures. The cellulose acetate tow was processed through an air banding jet which utilizes air to spread a tow in a direction perpendicular to the direction of travel, thus opening and spreading the cellulose acetate tow. The opened cellulose acetate tow was then deregistered by a pair of driven rollers to stretch the cellulose acetate fibers. Then, a plasticizer (e.g., triacetin) was applied to the deregistered cellulose acetate tow. The plasticizer (e.g., triacetin) was sprayed using a nozzle onto the top surface of the cellulose acetate tow and spray roller brushes applied plasticizer onto the bottom surface of the cellulose acetate tow. In Table 1, PZ (plasticizer) top represents the pump speed of the spray nozzle for delivering the plasticizer onto the top surface of the cellulose acetate tow. The pump speed correlates to the amount of the plasticizer that is delivered to the top surface of the cellulose acetate tow. In Table 1, PZ bottom represents the amount of plasticizer applied to the bottom surface of the cellulose acetate tow. To apply plasticizer to the bottom surface of the cellulose acetate tow band, a brush submerged in a bath comprising plasticizer (e.g., triacetin) is operated at a roller speed to deliver the plasticizer to the bottom surface of the cellulose acetate tow. The brush spread (RPM) determined the amount of plasticizer applied (e.g., sprayed) to the bottom surface of the cellulose acetate tow band. After the plasticizer was applied to the top and bottom surfaces of the cellulose acetate tow, the cellulose acetate tow was bulked using an air jet to spread and open the cellulose acetate tow. The cellulose acetate tow was then calendared using heated rollers at specific temperatures to embed the plasticizer in the fibers to maintain the integrity of the fibers and to control the thickness of the cellulose acetate tow for use as a filter structure. The results are shown in Tables 1 and 2 below.

TABLE 1

| | | | | | Top and | Total | | |
|---|---|---|---|---|---|---|---|---|
| | Denier | | PZ Top | PZ | Bottom | Amount | Average | |
| | Per | Total | (% Pump | Bottom | Roller | of PZ | Permeability | Structural |
| | Filament | Denier | Speed) | (RPM) | (° C.) | (wt. %) | (cm³/s) | Integrity |
| Ex. 1 | 2.40 | 42600 | 5 | 102 | 93.3 | 2.49 | 6631 | Good |
| Ex. 2 | 2.40 | 42600 | 17 | 242 | 93.3 | 9.55 | 11,081 | Good |
| Ex. 3 | 2.14 | 29700 | 5 | 100 | 93.3 | 2.46 | 6848 | Good |
| Ex. 4 | 2.70 | 35000 | 12 | 180 | 93.3 | 4.41 | 4847 | Good |
| Ex. 5 | 2.70 | 35000 | 2 | 80 | 93.3 | 2.26 | 10,288 | Good |
| Ex. 6 | 1.90 | 39000 | 2 | 80 | 93.3 | 2.8 | 7013 | Good |
| Comp. A | 2.14 | 29700 | 0.5 | 100 | 76.7 | — | 12,417 | Poor |
| Comp. B | 1.90 | 39000 | 1 | 20 | 71.1 | — | 57,412 | Poor |

As shown in Table 1, the temperature of the heated rollers impacted the structural integrity of the filter structures. Specifically, Comparative Examples A and B were processed through heated rollers operating at a temperature of 77° C. or less and resulted in poor structural integrity. The cellulose acetate fibers of Comparative Examples A and B did not have enough strength to retain shape (e.g., broke apart). In contrast, Examples 1-6 were processed through heated rollers operating at a temperature of 93.3° C. resulted in good structural integrity and were able to retain their shape. Additionally, the look and feel of Examples 1-6 were significantly better than Comparative Examples A and B.

TABLE 2

| | | | | | Top and | Total | |
|---|---|---|---|---|---|---|---|
| | Denier | | PZ Top | PZ | Bottom | Amount | Average |
| | Per | Total | (% Pump | Bottom | Roller | of PZ | Permeability |
| | Filament | Denier | Speed) | (RPM) | (° C.) | (wt. %) | (cm³/s) |
| Ex. 7 | 2.4 | 42600 | 35 | 550 | 148.9 | 8.61 | 4474 |
| Ex. 8 | 2.4 | 42600 | 12 | 185 | 93.3 | 0.64 | 35859 |
| Ex. 9 | 2.14 | 29700 | 35 | 545 | 148.9 | 11.83 | 4550 |
| Ex. 10 | 2.14 | 29700 | 12 | 185 | 79.4 | 1.03 | 70207 |
| Ex. 11 | 2.7 | 35000 | 23 | 360 | 93.3 | 7.15 | 13696 |
| Ex. 12 | 2.7 | 35000 | 35 | 550 | 65.6 | 12.5 | 57951 |
| Ex. 13 | 1.9 | 39000 | 35 | 550 | 148.9 | 9.96 | 2888 |
| Ex. 14 | 1.9 | 39000 | 12 | 185 | 79.4 | 1.43 | 41923 |

As shown in Table 2, the specific fibers of the cellulose acetate (e.g., dpf and total denier), the amount of plasticizer, and the process parameters can each impact the air permeability and filtration efficiency of the filter structure. For Examples 7 and 8, the air permeability was 4474 cm³/s and 35859 cm³/s, respectively, despite having the same dpf and total denier. The amount of the plasticizer in the cellulose acetate tow and the roller temperatures for producing Examples 7 and 8 affected the air permeability of the filter structure. Similarly, Examples 13 and 14, which has a lower dpf than the other examples, also had a large variance in air permeability. The process parameters (e.g., roller temperatures) and the amount of plasticizer affected the air permeability of the filter structure.

### Example 2

As shown in Table 3, Examples 15, 16, and 17 were investigated for air permeability, bacteria filtration efficiency, and particle filtration efficiency. The air permeability, bacteria filtration efficiency, and particle filtration efficiency were tested according to the testing methods described herein. Specifically, the air permeability was measured using a Frazier Air Permeability Tester available from the Frazier Precision Instrument Company, the bacteria filtration efficiency was measured according to ASTM F2100 (2020), and particle filtration efficiency was measured according to ASTM F2101 (2020).

TABLE 3

| | | | | | Top and | Total |
|---|---|---|---|---|---|---|
| | Denier | | PZ Top | PZ | Bottom | Amount |
| | Per | Total | (% Pump | Bottom | Roller | of PZ |
| | Filament | Denier | Speed) | (RPM) | (° C.) | (wt. %) |
| Ex. 15 | 1.9 | 39000 | 17.5 | 225 | 148.9 | 1.89 |
| Ex. 16 | 2.14 | 29700 | 35 | 550 | 65.6 | 13.87 |
| Ex. 17 | 2.7 | 35000 | 35 | 550 | 82.2 | 21.29 |

| | Air | Flame | | BFE | | PFE |
|---|---|---|---|---|---|---|
| | Permeability | Test | BFE (%) | Range | PFE (%) | Range |
| | (cm³/s) | (inches) | 3 microns | (%) | 1 micron | (%) |
| Ex. 15 | 5333 | 0 | 98.2 | 97.3-98.9 | 91.7 | 90-93.2 |
| Ex. 16 | 52528 | 8 | 72 | 70-73 | 85 | 82-87 |
| Ex. 17 | 38039 | 2 | 83.6 | 82-86 | 82.3 | 79-89 |

The bacteria filtration efficiency and particle filtration efficiency in Table 3 was taken as the average value of 3 tests. The filter structure of Example 15, which had a dpf of 1.9, a total denier of 39,000, and 1.89 wt. % plasticizer, exhibited the highest values for bacteria filtration efficiency from 97.3% to 98.9% and particle filtration efficiency from 90% to 93.2%. Example 16, which was processed through heated rollers at the lowest temperatures, had the lowest bacteria filtration efficiency. Examples 16 and 17 had comparable or better breathability values to conventional polypropylene filters.

### Example 3

The filter structures of Examples 18-23 were produced according to the same method as Example 1. The filter structures of Examples 18-23 were produced for use as a filter layer or an insert in a protective covering. The results are shown in Table 4.

TABLE 4

| | | | | | Top and | Total | | | |
|---|---|---|---|---|---|---|---|---|---|
| | | | PZ Top | PZ | Bottom | Amount | | | Average |
| | | Total | (% Pump | Bottom | Roller | of PZ | Weight | Thickness | Permeability |
| Ex. | DPF | Denier | Speed) | (RPM) | (° C.) | (wt. %) | (GSM) | (mm) | (cm³/s) |
| 18 | 2.4 | 42600 | 10 | 165 | 93.3 | 4.7 | 80.6 | 0.2137 | 6975 |
| 19 | 2.14 | 29700 | 5 | 102 | 93.3 | 3.2 | 91.6 | 0.1355 | 7381 |
| 20 | 1.9 | 39000 | 2 | 80 | 93.3 | 2.8 | 155.5 | 0.0398 | 7013 |
| 21 | 2.7 | 35000 | 2 | 80 | 93.3 | 2.3 | 103.9 | 0.2967 | 10289 |
| 22 | 2.7 | 35000 | 12 | 0 | 93.3 | 4 | 110.3 | 0.2856 | 5295 |
| 23 | 1.9 | 39000 | 0.5 | 100 | 76.7 | 2.8 | 110.3 | 0.499 | 27472 |

As shown in Table 4, the processing conditions were tailored to achieve a desired thickness of the filter structure. The feed of the cellulose acetate tow into the hot rollers controlled the thickness, volume, and weight of the resulting filter structure. The greater the amount of cellulose acetate tow that is feed through the rollers, the higher the thickness and the weight (gsm). In comparison to the results in Example 1, the thickness and weight of Examples 18-23 is substantially lower, which may be more desirable for use in protective coverings. The thinner and lighter filter structures of Examples 18-23 can be used as inserts in a protective covering or as an individual layer of a protective covering. The combination of dpf, total denier, plasticizer, hot roller temperature, and roller speeds can be optimized to achieve desirable properties of a filter structure comprising cellulose acetate tow and plasticizer.

### Example 4

Three cellulose acetate filter layers were prepared as Examples 24, 25, and 26, each comprising triacetin as plasticizer. Ex 26 was measured and comprised 1.71 wt. % triacetin. The denier per filament and total denier of the cellulose acetate are reported in Table 5. Comp. 3 is a commercially available insert layer made from polypropylene reference sample. Comp. D is a filter structure using a commercially available polyester outer layer only. Comp. E is a filter structure using a combination of a commercially available polypropylene insert with a commercially available polyester outer layer. Finally, Ex. 27 is a combination of the cellulose acetate insert of Ex. 26 combined with a commercially available polyester outer layer. As can be seen from the results reported in Table 5, Ex. 27 had similar performance to Comp. E and far superior performance to Comp. D. Thus, the combination of a cellulose acetate insert with a commercially available polyester outer layer achieved satisfactory filtration as compared to Comp. E, but with the environmental advantages of reducing polypropylene usage.

TABLE 5

| | | CA | | | | | Differential | |
|---|---|---|---|---|---|---|---|---|
| | CA | Total | BFE (%) | | PFE % | | Pressure | |
| | DPF | Denier | (3 micron) | Range | (1 micron) | Range | (mm/Wg) | Range |
| Comp. C | N/A | N/A | 92.9 | 89-95.3 | X | X | 1 | 0 |
| Ex. 24 | 2.14Y | 29,700 | 71.3 | 69-74 | 57.6 | 53-61 | 2.5 | 2.3-2.7 |
| Ex. 25 | 2.4Y | 42,600 | 72.3 | 73-76 | 75.3 | 67-82 | 1.53 | 1.5-1.6 |
| Ex. 26 | 1.88 | 38,800 | 61.3 | 54-68 | 78 | 77-80 | 1.53 | 1.3-1.7 |
| Comp. D | N/A | N/A | 47.6 | 41-54 | X | X | X | X |
| Comp. E | N/A | N/A | 96.1 | 95-96.4 | X | X | X | X |
| Ex. 27 | N/A | N/A | 86.2 | 81-90.6 | X | X | X | X |

### Embodiments

Embodiment 1: A protective covering comprising a filter structure comprising cellulose acetate and optionally plasticizer, wherein the filter structure has an average air permeability from 450 cm³/s to 95,000 cm³/s, optionally wherein the filter structure comprises the cellulose acetate layer as an insert and a polyester layer as an outer layer.

Embodiment 2: An embodiment of any preceding or subsequent embodiment, wherein the cellulose acetate comprises cellulose acetate tow, cellulose acetate fibers, cellulose acetate staple fibers, melt-spun cellulose acetate fibers, electro-spun cellulose acetate fibers, or combinations thereof.

Embodiment 3: An embodiment of any preceding or subsequent embodiment, wherein the cellulose acetate is non-woven.

Embodiment 4: An embodiment of any preceding or subsequent embodiment, wherein the cellulose acetate comprises from 1 denier per filament to 4 denier per filament.

Embodiment 5: An embodiment of any preceding or subsequent embodiment, wherein the cellulose acetate comprises from 15,000 total denier to 45,000 total denier.

Embodiment 6: An embodiment of any preceding or subsequent embodiment, wherein the cellulose acetate has a filament count from 10,000 filaments to 25,000 filaments.

Embodiment 7: An embodiment of any preceding or subsequent embodiment, the filter structure further comprises an antimicrobial on a front side or a back side of the filter structure.

Embodiment 8: An embodiment of any preceding or subsequent embodiment, wherein the filter structure has a bacteria filtration efficiency of at least 50% as measured by ASTM F2101 (2020).

Embodiment 9: An embodiment of any preceding or subsequent embodiment, wherein the filter structure has a particle filtration efficiency of at least 50% as measured by ASTM F2100 (2020).

Embodiment 10: An embodiment of any preceding or subsequent embodiment, wherein the filter structure comprises cellulose acetate tow and plasticizer, wherein an amount of plasticizer ranges from 0.1 wt. % to 25 wt. %, based on the total weight of cellulose acetate tow.

Embodiment 11: An embodiment of any preceding or subsequent embodiment, wherein the plasticizer comprises triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, carbowax, glycerin, and combinations thereof.

Embodiment 12: An embodiment of any preceding or subsequent embodiment, wherein the plasticizer comprises triacetin.

Embodiment 13: An embodiment of any preceding or subsequent embodiment, wherein the filter structure comprises cellulose acetate tow and plasticizer in a ratio from 100:1 to 3:1.

Embodiment 14: A protective covering comprising: an outer layer; an inner layer opposite the outer layer, the outer layer and the inner layer being connected; and a middle layer disposed between the outer layer and the inner layer, wherein at least one of the outer layer, inner layer, or middle layer comprises cellulose acetate and optionally plasticizer, wherein the cellulose acetate comprises cellulose acetate tow, cellulose acetate fibers, cellulose acetate staple fibers, melt-spun cellulose acetate fibers, electro-spun cellulose acetate fibers, or combinations thereof.

Embodiment 15: An embodiment of any preceding or subsequent embodiment, wherein the cellulose acetate is non-woven.

Embodiment 16: An embodiment of any preceding or subsequent embodiment, wherein the cellulose acetate comprises from 1 denier per filament to 4 denier per filament.

Embodiment 17: An embodiment of any preceding or subsequent embodiment, wherein the cellulose acetate comprises from 28,000 total denier to 45,000 total denier.

Embodiment 18: An embodiment of any preceding or subsequent embodiment, wherein the cellulose acetate has a filament count from 10,000 filaments to 25,000 filaments.

Embodiment 19: An embodiment of any preceding or subsequent embodiment, wherein the at least one of the outer layer, inner layer, or middle layer comprises an antimicrobial.

Embodiment 20: An embodiment of any preceding or subsequent embodiment, wherein the at least one layer has a bacteria filtration efficiency of at least 50% as measured by ASTM F2101 (2020).

Embodiment 21: An embodiment of any preceding or subsequent embodiment, wherein the at least one layer has a particle filtration efficiency of at least 50% as measured by ASTM F2100 (2020).

Embodiment 22: An embodiment of any preceding or subsequent embodiment, wherein the at least one layer comprises cellulose acetate tow and plasticizer, wherein an amount of plasticizer ranges from 0.1 wt. % to 25 wt. %, based on the total weight of cellulose acetate tow.

Embodiment 23: An embodiment of any preceding or subsequent embodiment, wherein the plasticizer comprises triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, carbowax, glycerin, and combinations thereof.

Embodiment 24: An embodiment of any preceding or subsequent embodiment, wherein the plasticizer comprises triacetin.

Embodiment 25: An embodiment of any preceding or subsequent embodiment, wherein the at least one layer comprises cellulose acetate tow and plasticizer in a ratio from 100:1 to 3:1.

Embodiment 26: A protective covering comprising: an outer layer; an inner layer attached to the outer layer to form a pocket; and a filter structure disposed in the pocket, the filter structure comprising cellulose acetate and optionally plasticizer, the filter structure having an average air permeability from 450 cm³/s to 95,000 cm³/s, wherein the cellulose acetate comprises cellulose acetate tow, cellulose acetate fibers, cellulose acetate staple fibers, melt-spun cellulose acetate fibers, electro-spun cellulose acetate fibers, or combinations thereof.

Embodiment 27: An embodiment of any preceding or subsequent embodiment, wherein the outer layer and inner layer are a single layer.

Embodiment 28: An embodiment of any preceding or subsequent embodiment, wherein the outer layer and inner comprises cellulose acetate tow, cellulose acetate fibers, cellulose acetate staple fibers, melt-spun cellulose acetate fibers, electro-spun cellulose acetate fibers, or combinations thereof.

Embodiment 29: An embodiment of any preceding or subsequent embodiment, wherein the filter structure has a bacteria filtration efficiency of at least 50% as measured by ASTM F2101 (2020).

Embodiment 30: An embodiment of any preceding or subsequent embodiment, wherein the filter structure has a particle filtration efficiency of at least 50% as measured by ASTM F2100 (2020).

Embodiment 31: An embodiment of any preceding or subsequent embodiment, further comprising an attachment strap comprising a biodegradable material.

Embodiment 32: An embodiment of any preceding or subsequent embodiment, wherein the outer layer and inner layer comprise polypropylene, polyester, or combinations thereof.

Embodiment 33: An embodiment of any preceding or subsequent embodiment, wherein the outer layer and the inner layer comprise a bio-based material.

Embodiment 34: An embodiment of any preceding or subsequent embodiment, wherein the bio-based material comprises one or more of cellulose acetate, viscose, rayon, cotton, wool, bamboo, tencel, linen, or hemp.

Embodiment 35: An embodiment of any preceding or subsequent embodiment, wherein the filter structure comprises cellulose acetate tow and plasticizer.

Embodiment 36: An embodiment of any preceding or subsequent embodiment, wherein an amount of plasticizer ranges from 0.1 wt. % to 25 wt. %, based on the total weight of cellulose acetate tow.

Embodiment 37: An embodiment of any preceding or subsequent embodiment, wherein the plasticizer comprises triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, carbowax, glycerin, and combinations thereof.

Embodiment 38: An embodiment of any preceding or subsequent embodiment, wherein the plasticizer comprises triacetin.

Embodiment 39: An embodiment of any preceding or subsequent embodiment, wherein the filter structure comprises cellulose acetate tow and plasticizer in a ratio from 100:1 to 3:1.

Embodiment 40: A filter structure comprising: cellulose acetate tow; and a plasticizer, wherein the filter structure has a bacteria filter efficiency of at least 50% as measured by ASTM F2101 (2020), wherein the filter structure has a particle filter efficiency of at least 50% as measured by ASTM F2100 (2020), and wherein the filter structure has an average air permeability from 450 cm³/s to 95,000 cm³/s.

Embodiment 41: An embodiment of any preceding or subsequent embodiment, wherein the filter structure has a bacteria filter efficiency of at least 70% as measured by ASTM F2101 (2020), wherein the filter structure has a particle filter efficiency of at least 80% as measured by ASTM F2100 (2020), and wherein the filter structure has an average air permeability from 28,000 cm³/s to 48,000 cm³/s.

Embodiment 42: An embodiment of any preceding or subsequent embodiment, wherein filaments of the cellulose acetate tow have a cross-sectional shape selected from the group comprising circular, substantially circular, crenulated, ovular, substantially ovular, polygonal, substantially polygonal, dog-bone, “Y,” “X,” “K,” “C,” multi-lobe, and any combination thereof.

Embodiment 43: An embodiment of any preceding or subsequent embodiment, wherein the plasticizer is provided in an amount from 0.1 wt. % to 25 wt. %, based on the total weight of cellulose acetate tow.

Embodiment 44: An embodiment of any preceding or subsequent embodiment, wherein the plasticizer comprises one or more of triacetin, carbowax, polyethylene glycol, and glycerin.

Embodiment 45: An embodiment of any preceding or subsequent embodiment, wherein the filter structure comprises cellulose acetate tow and plasticizer in a ratio from 100:1 to 3:1.

Embodiment 46: An embodiment of any preceding or subsequent embodiment, wherein the filter structure weighs from 50 gsm to 200 gsm and has a thickness less than 2 mm.

Embodiment 47: An embodiment of any preceding or subsequent embodiment, wherein the cellulose acetate tow comprises from 1 denier per filament to 4 denier per filament, wherein the cellulose acetate tow comprises from 28,000 total denier to 45,000 total denier, wherein the cellulose acetate tow has a filament count from 10,000 filaments to 25,000 filaments.

Embodiment 48: A method of producing a filter structure, the method comprising: providing a cellulose acetate tow; spreading the cellulose acetate tow through an air banding jet to open the cellulose acetate tow; optionally deregistering the cellulose acetate tow to spread fibers of the cellulose acetate tow; bulking the cellulose acetate tow using an air jet; applying plasticizer to the bulked cellulose acetate tow; calendaring the bulked tow between heated rollers operating in a temperature range from 65° C. and 125° C.; and cutting the bulked tow to form a filter structure.

Embodiment 49: An embodiment of any preceding or subsequent embodiment, wherein an amount of plasticizer added to the cellulose acetate tow ranges from 0.1 wt. % to 25 wt. %, based on the total weight of the cellulose acetate tow.

Embodiment 50: An embodiment of any preceding or subsequent embodiment, wherein an amount of plasticizer added to the cellulose acetate tow is from 0.5 wt. % to 20 wt. % based on the total cellulose acetate tow, the calendaring temperature is from 65° C. and 125° C., wherein a bacteria filter efficiency of the filter structure is at least 50% as measured by ASTM F2101 (2020), wherein a particle filter efficiency of the filter structure is at least 50% as measured by ASTM F2100 (2020), and wherein an average air permeability of the filter structure is from 450 cm³/s to 95,000 cm³/s.

While the invention has been described in detail, modifications within the spirit and scope of the invention will be readily apparent to those of skill in the art. It should be understood that aspects of the invention and portions of various embodiments and various features recited above and/or in the appended claims may be combined or interchanged either in whole or in part. In the foregoing descriptions of the various embodiments, those embodiments which refer to another embodiment may be appropriately combined with other embodiments as will be appreciated by one of ordinary skill in the art. Furthermore, those of ordinary skill in the art will appreciate that the foregoing description is by way of example only, and is not intended to limit the invention.

We claim:

1. A protective covering comprising a filter structure comprising cellulose acetate and optionally plasticizer, wherein the filter structure has an average air permeability from 450 cm³/s to 95,000 cm³/s.

2. The protective covering of claim 1, wherein the cellulose acetate comprises cellulose acetate tow, cellulose acetate fiber, cellulose acetate staple fibers, melt-spun cellulose acetate fibers, electro-spun cellulose acetate fibers, or combinations thereof.

3. The protective covering of claim 1, wherein the cellulose acetate is non-woven.

4. The protective covering of claim 1, wherein the cellulose acetate comprises from 1 denier per filament to 4 denier per filament.

5. The protective covering of claim 1, wherein the cellulose acetate comprises from 15,000 total denier to 45,000 total denier.

6. The protective covering of claim 1, wherein the cellulose acetate has a filament count from 10,000 filaments to 25,000 filaments.

7. The protective covering of claim 1, wherein the protective covering comprises an antimicrobial on a front side or a back side of the filter structure.

8. The protective covering of claim 1, wherein the filter structure has a bacteria filtration efficiency of at least 50% as measured by ASTM F2101 (2020).

9. The protective covering of claim 1, wherein the filter structure has a particle filtration efficiency of at least 50% as measured by ASTM F2100 (2020).

10. The protective covering of claim 1, wherein the filter structure comprises cellulose acetate tow and plasticizer, wherein an amount of plasticizer ranges from 0.1 wt. % to 25 wt. %, based on the total weight of cellulose acetate tow.

11. The protective covering of claim 10, wherein the plasticizer comprises triacetin, diacetin, tripropionin, trimethyl citrate, triethyl citrate, tributyl citrate, eugenol, cinnamyl alcohol, alkyl lactones (e.g., γ-valerolactone), methoxy hydroxy acetophenone (acetovanillone), vanillin, ethylvanillin, polyethylene glycols, 2-phenoxyethanol, glycol ethers, ethylene glycol ethers, propylene glycol ethers, polysorbate surfactants, sorbitan ester surfactants, polyethoxylated aromatic hydrocarbons, polyethoxylated fatty acids, polyethoxylated fatty alcohols, carbowax, glycerin, and combinations thereof.

12. The protective covering of claim 10, wherein the filter structure comprises cellulose acetate tow and plasticizer in a ratio from 100:1 to 3:1.

13. The protective covering of claim 1, wherein the filter structure comprises:
an outer layer;
an inner layer opposite the outer layer, the outer layer and the inner layer being connected; and
a middle layer disposed between the outer layer and the inner layer,
wherein at least one layer of the outer layer, inner layer, or middle layer comprises the cellulose acetate and optionally the plasticizer.

14. The protective covering of claim 1, comprising:
an outer layer;
an inner layer attached to the outer layer to form a pocket; and
a filter structure disposed in the pocket, the filter structure comprising the cellulose acetate and optionally the plasticizer.

15. The protective covering claim 14, wherein the outer layer and inner layer are a single layer.

16. The protective covering of claim 15, wherein the outer layer and inner layer each comprise cellulose acetate tow, cellulose acetate fibers, cellulose acetate staple fibers, melt-spun cellulose acetate fibers, electro-spun cellulose acetate fibers, or combinations thereof.

17. The protective covering of claim 14, further comprising an attachment strap comprising a biodegradable material.

18. The protective covering of claim 14, wherein the outer layer and the inner layer comprise a bio-based material.

19. The protective covering of claim 18, wherein the bio-based material comprises one or more of cellulose acetate, viscose, rayon, cotton, wool, bamboo, tencel, linen, or hemp.

20. A method of producing a filter structure, the method comprising:
providing a cellulose acetate tow;
spreading the cellulose acetate tow through an air banding jet to open the cellulose acetate tow;
optionally deregistering the cellulose acetate tow to spread fibers of the cellulose acetate tow;
bulking the cellulose acetate tow using an air jet to produce a bulked cellulose acetate tow;
applying plasticizer to the bulked cellulose acetate tow;
calendaring the bulked cellulose acetate tow between heated rollers operating in a temperature range from 65° C. and 125° C.; and
cutting the bulked tow to form a filter structure.
